(19) United States
(12) Patent Application Publication
(10) Pub. No.: US 2008/0198851 A1
(43) Pub. Date: Aug. 21, 2008

(54) INFORMATION PROCESSING SYSTEM INCLUDING INFORMATION PROCESSING APPARATUS AND TERMINALS, AND INFORMATION PROCESSING METHOD FOR THE SAME

(76) Inventors: ICHIRO YAMAGUCHI, Tokyo (JP); AKIRA TSUKAMOTO, Tokyo (JP)

Correspondence Address: NEC CORPORATION OF AMERICA, 6535 N. STATE HWY 161, IRVING, TX, 75039, US

(21) Appl. No.: 12/031,342

(22) Filed: Feb. 14, 2008

(30) Foreign Application Priority Data
Feb. 19, 2007 (JP) 2007-037487

(51) Int. Cl. H04L 12/56

(52) U.S. Cl. 370/392

(57) ABSTRACT

An information processing system includes an information processing apparatus configured to perform a call control; and terminals configured to communicate with the information processing apparatus. The information processing apparatus sets an SDP in an SIP message based on network connection environment data indicating existence or non-existence of a NAT (Network Address Translator) apparatus connected with each of the terminals and a type of the NAT apparatus.

This patent application is based on Japanese patent application No. 2007-037487 dated Feb. 19, 2007. The disclosure thereof is incorporated herein by reference.

### TECHNICAL FIELD

The present invention relates to an information processing system including an information processing apparatus and terminals, and an information processing method in the same. More particularly, the present invention relates to an information processing system including an information processing apparatus and terminals, and an information processing method, in which call control is performed in a communication between terminals when a NAT (Network Address Translation) apparatus is provided in a network.

### BACKGROUND ART

A NAT apparatus will be described. The NAT apparatus allows a terminal to which only a local IP address is assigned, to access to the Internet by exchanging a private IP address and a global IP address, which makes it possible to directly access to the Internet. When the above terminal perform communication, the NAT apparatus maps the local IP address and a port number written in a communication packet, to a global IP address and a port number assigned to the NAT apparatus.

When terminals connected under different NAT apparatuses directly communicate with each other, it is necessary to know global IP addresses and port numbers of the NAT apparatuses mapped to local IP addresses and port numbers assigned to the terminals.

With reference to “RFC 3489: Simple Traversal of User Datagram Protocol (UDP) Through Network Address Translators (NATs)” (Internet Society, March 2003: first related art) by Jonathan Rosenberg et al., the STUN (Simple Traversal of User Datagram Protocol Through Network Address Translators) system is proposed as a method of knowing the mapped IP addresses and port numbers. This system is not always applicable to every NAT apparatus, due to a mapping method for an IP address and a port number of NAT apparatuses. The mapping method is classified into four types, a Full Cone type, a Restricted Cone type, a Port Restricted Cone type, and a Symmetric type.

As a related art, Japanese Patent Application Publication (JP-P2006-253824A: second related art) discloses a communication apparatus and a communication method. In this second related art, NAT functions are classified into four types: a Full Cone NAT, a Restricted Cone NAT, a Port Restricted Cone NAT, and a Symmetric NAT. It is described that a message to request a test of address translation algorithm of a router is repeatedly transmitted and received and when a response message thereto cannot be received, a message to request a test for further judgment is transmitted to judge the address translation algorithm of the router in high precision based on a response message to the message of the further judgment can be received or not.

In a case of the NAT apparatuses with the name of “Cone” (Cone NAT apparatuses), which are of the Full Cone type, the Restricted Cone type, or the Port Restricted Cone type, a global IP address and a port number assigned to a NAT apparatus can be obtained by the STUN, and communication is possible between the terminals connected under different NAT apparatuses. However, in a NAT apparatus of the Symmetric type, as shown in “NAT Traversal Technology and Its Mechanism” (third related art) by Yuji Sunouchi, an IP address and a port number assigned to a NAT apparatus cannot be obtained and communication between the terminals is not possible even by using the STUN. In this case, a relay apparatus to which a global IP address is assigned, is required.

In communication using an SIP (Session Initiation Protocol), the same problem as described above is caused when communication is performed with a terminal connected under a NAT apparatus. This is because an SDP (Session Description Protocol) of an SIP message requires an IP address and a port number for the main signal communication.

Japanese Patent Application Publication (JP-P2006-005754A: fourth related art) discloses an SIP signal translation method, and an SIP-ALG apparatus. When an IP address and a port number of an SIP signal are translated by an SIP-ALG (SIP-Application Level Gateway), network identification data of a NAT apparatus, an IP address and a port number in an SDP before translation, and an IP address and a port number after translation are set as a unique SIP header in an SIP signal transmitted from a private network to a global network. In an SIP signal transmitted from the global network to the private network, a unique SIP header, and the network identification data of a NAT apparatus and an SDP are compared to judge whether terminals are in a same private network. In the case of SIP communication between the terminals in the same private network, an IP address and a port number of an SDP are translated into an IP address and a port number before translation included in a unique SIP header.

Japanese Patent Application Publication (JP-P2006-101463A: fifth related art) discloses a call control system of a tunnel apparatus, a relay apparatus, and terminals. When a direct path should be performed between terminals in different LANs, a test packet is transmitted from a reception port of one terminal to a relay apparatus across a FW. On the other hand, a hole punching packet is not transmitted. When a voice packet is transmitted thereafter from the other terminal in a given time, the terminal judges to be the Full Cone NAT since the FW of the former terminal passes a data from a FW of the latter terminal with an IP address different from that of the relay apparatus, which is the transmission destination of the test packet. When a voice packet is not transmitted from the latter terminal in the given time, a hole punching packet is transmitted from the reception port of the former terminal to a port different from a port of WAN-side identification data of a transmission port of the latter terminal. As a result, when the voice packet is transmitted from the latter terminal in a given time, the former terminal judges to be the Restricted Cone NAT since the FW of the former terminal permits the difference between the port numbers provided that the transmission destination of the hole punching packet and the IP address are coincident with each other. When the voice packet is not transmitted from the latter terminal in a second given time, a hole punching packet is transmitted from the reception port of the former terminal to the port of WAN-side identification data of the transmission port of the latter terminal. As a result, when the voice packet is transmitted from the latter terminal in the second given time, the former terminal judges to be the Port-Restricted Cone NAT since the FW of the former terminal permits the packets to pass in the reverse direction only when the transmission destination of the hole punching packet and the IP address and the port number are coincident with each other. Also, in this case, when the voice packet cannot still received from the latter terminal in a third given time, the FW on the side of the former terminal is judged to be the Symmetric NAT.

In the NAT apparatuses, communication is not possible depending on types of the NAT apparatus when communication using the SIP is performed between terminals with local IP addresses under the NAT apparatuses. Also, an excessive processing load is applied to a NAT apparatus, when terminals under a same NAT apparatus perform the main signal communication since the communication is performed over the NAT apparatus.

### SUMMARY

An object of the present invention is to provide an information processing system having an information processing apparatus and terminals, and an information processing method for the same, in which network connection environment data indicating whether or not a terminal is under a NAT apparatus is known as well as the type of the NAT apparatus.

In an aspect of the present invention, an information processing system includes an information processing apparatus configured to perform a call control; and terminals configured to communicate with the information processing apparatus. The information processing apparatus sets an SDP in an SIP message based on network connection environment data indicating existence or non-existence of a NAT (Network Address Translator) apparatus connected with each of the terminals and a type of the NAT apparatus.

In another aspect of the present invention, an information processing apparatus includes a network connection environment managing section configured to acquire network connection environment data indicating existence or non-existence of a NAT (Network Address Translator) apparatus and a type of the NAT apparatus which is connected with a terminal and to notify a main signal communication setting data of the terminal; a SIP control section configured to receive a SIP message transmitted from the terminal and to perform a control in response to a request from the terminal; a user data storage section configured to store the network connection environment data and a registered user data from the terminal; a main signal route determining section configured to determine a route of a main signal based on the network connection environment data stored in the user data storage section; a main signal route setting section configured to rewrite the SIP message to perform communication on the route determined by the main signal route determining section; and a main signal relaying section configured to relay the main signal based on data of the main signal route setting section.

In another aspect of the present invention, an information processing method includes communicating between an information processing apparatus which performs a call control and a terminal; and setting an SDP in a SIP message based on a network connection environment data indicating existence or non-existence of a NAT (Network Address Translator) apparatus which is connected with the terminal, and a type of the NAT apparatus in the information processing apparatus.

In still another aspect of the present invention, an information processing method includes managing at least one terminal by each of information processing apparatuses which perform call control; and setting an SDP in a SIP message based on a network connection environment data indicating existence or non-existence of a NAT (Network Address Translator) apparatus which is connected with the terminal, and a type of the NAT apparatus in each of the information processing apparatuses.

In still another aspect of the present invention, a computer-readable software medium is provided in which a program code is written to realize an information processing method. The method includes managing at least one terminal by each of information processing apparatuses which perform call control; and setting an SDP in a SIP message based on a network connection environment data indicating existence or non-existence of a NAT (Network Address Translator) apparatus which is connected with said terminal, and a type of said NAT apparatus in each of said information processing apparatuses.

According to an information processing system including an information processing apparatus and terminals of the present invention, the terminals can certainly communicate with each other by appropriately setting an IP address and a port number for a main signal of an SIP message based on network connection environment data of the terminals. Also, a processing load of the NAT apparatus can be reduced by performing direct communication between the terminals in the main signal communication between the terminals under a same NAT apparatus.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1A is a block diagram showing a configuration of an information processing system according to a first exemplary embodiment of the present invention when no NAT apparatus is present;

FIG. 1B is a diagram showing a message sequence in the information processing system according to the first exemplary embodiment of the present invention;

FIG. 1C is a sequence diagram in the information processing system according to the first exemplary embodiment of the present invention;

FIG. 2A is a block diagram showing a configuration of the information processing system according to the first exemplary embodiment of the present invention when a terminal is connected to a NAT apparatus;

FIG. 2B is a diagram showing a message sequence in the information processing system according to the first exemplary embodiment of the present invention when the NAT apparatus is a Corn NAT apparatus;

FIG. 2C is a sequence diagram in the information processing system according to the first exemplary embodiment of the present invention when the NAT apparatus is a Corn NAT apparatus;

FIG. 2D is a diagram showing a message sequence in the information processing system according to the first exemplary embodiment of the present invention when the NAT apparatus is a Symmetric NAT apparatus;

FIG. 2E is a sequence diagram in the information processing system according to the first exemplary embodiment of the present invention when the NAT apparatus is the Symmetric NAT apparatus;

FIG. 3A is a block diagram showing a configuration of the information processing system according to a first exemplary embodiment of the present invention when terminals are connected to NAT apparatuses;

FIG. 3B is a diagram showing a message sequence in the information processing system according to the first exemplary embodiment of the present invention when both the NAT apparatuses are Cone-type NAT apparatuses;

FIG. 3C is a sequence diagram in the information processing system according to the first exemplary embodiment of the present invention when both the NAT apparatuses are the Cone-type NAT apparatuses;

FIG. 3D is a diagram showing a message sequence in the information processing system according to the first exemplary embodiment of the present invention when the NAT apparatuses are a Cone-type NAT apparatus and a Symmetric NAT apparatus;

FIG. 3E is a sequence diagram in the information processing system according to the first exemplary embodiment of the present invention when the NAT apparatuses are the Cone-type NAT apparatus and the Symmetric NAT apparatus;

FIG. 4A is a block diagram showing a configuration of the information processing system according to a first exemplary embodiment of the present invention when both the terminals are connected to the NAT apparatus;

FIG. 4B is a diagram showing a message sequence in the information processing system according to the first exemplary embodiment of the present invention when the terminals are connected to a same NAT apparatus;

FIG. 4C is a sequence diagram in the information processing system according to the first exemplary embodiment of the present invention when the terminals are connected to the same NAT apparatus;

FIG. 5A is a block diagram showing a configuration of the information processing system according to a second exemplary embodiment of the present invention when no NAT apparatus is present;

FIG. 5B is a diagram showing a message sequence in the information processing system according to the second exemplary embodiment of the present invention when no NAT apparatus is present;

FIG. 5C is a sequence diagram in the information processing system according to the second exemplary embodiment of the present invention when no NAT apparatus is present;

FIG. 6 is a diagram showing an SIP message when the information processing apparatuses exchange network connection environment data and main signal route data in the second exemplary embodiment of the present invention;

FIG. 7A is a block diagram showing a configuration of the information processing system according to the second exemplary embodiment of the present invention when the terminal is connected to a NAT apparatus;

FIG. 7B is a diagram showing a message sequence in the information processing system according to the second exemplary embodiment of the present invention when the NAT apparatus 20 is a Cone-type NAT apparatus;

FIG. 7C is a sequence diagram in the information processing system according to the second exemplary embodiment of the present invention when the NAT apparatus is the Cone-type NAT apparatus;

FIG. 7D is a diagram showing a message sequence in the information processing system according to the second exemplary embodiment of the present invention when the NAT apparatus is a Symmetric NAT apparatus;

FIG. 7E is a sequence diagram in the information processing system according to the second exemplary embodiment of the present invention when the NAT apparatus is a Symmetric NAT apparatus;

FIG. 8A is a block diagram showing a configuration of the information processing system according to the second exemplary embodiment of the present invention when the terminal 10 is connected to the NAT apparatus and the terminal 100 is connected to a NAT apparatus 200;

FIG. 8B is a diagram showing a message sequence in the information processing system according to the second exemplary embodiment of the present invention when both the NAT apparatuses are Cone-type NAT apparatuses;

FIG. 8C is a sequence diagram in the information processing system according to the second exemplary embodiment of the present invention when both the NAT apparatuses are the Cone-type NAT apparatuses;

FIG. 8D is a diagram showing a message sequence in the information processing system according to the second exemplary embodiment of the present invention when the NAT apparatuses are a Cone-type NAT apparatus and a Symmetric NAT apparatus;

FIG. 8E is a sequence diagram in the information processing system according to the second exemplary embodiment of the present invention when the NAT apparatuses are the Cone-type NAT apparatus and the Symmetric NAT apparatus;

FIG. 9A is a block diagram showing a configuration of the information processing system according to the second exemplary embodiment of the present invention when the terminals 10 and 100 are both connected to the NAT apparatus 20;

FIG. 9B is a diagram showing a message sequence in the information processing system according to the second exemplary embodiment of the present invention when the terminals are connected to the same NAT apparatus; and

FIG. 9C is a sequence diagram in the information processing system according to the second exemplary embodiment of the present invention when the terminals are connected to the same NAT apparatus.

### EXEMPLARY EMBODIMENTS

An information processing system of the present invention includes a section for recognizing and acquiring a data of network connection environment of each of terminals, a section for setting an IP address and a port number for main signal communication in an SIP message transmitted from each terminal based on the network connection environment data such that the communication is possible between the terminals, and a section for relaying a main signal when direct communication between the terminals through a NAT apparatus is not possible. The network connection environment data indicates whether or not the terminal is under the NAT apparatus, as well as a type of the NAT apparatus.

Hereinafter, the information processing system according to exemplary embodiments of the present invention will be described in detail with reference to the attached drawings.

### First Exemplary Embodiment

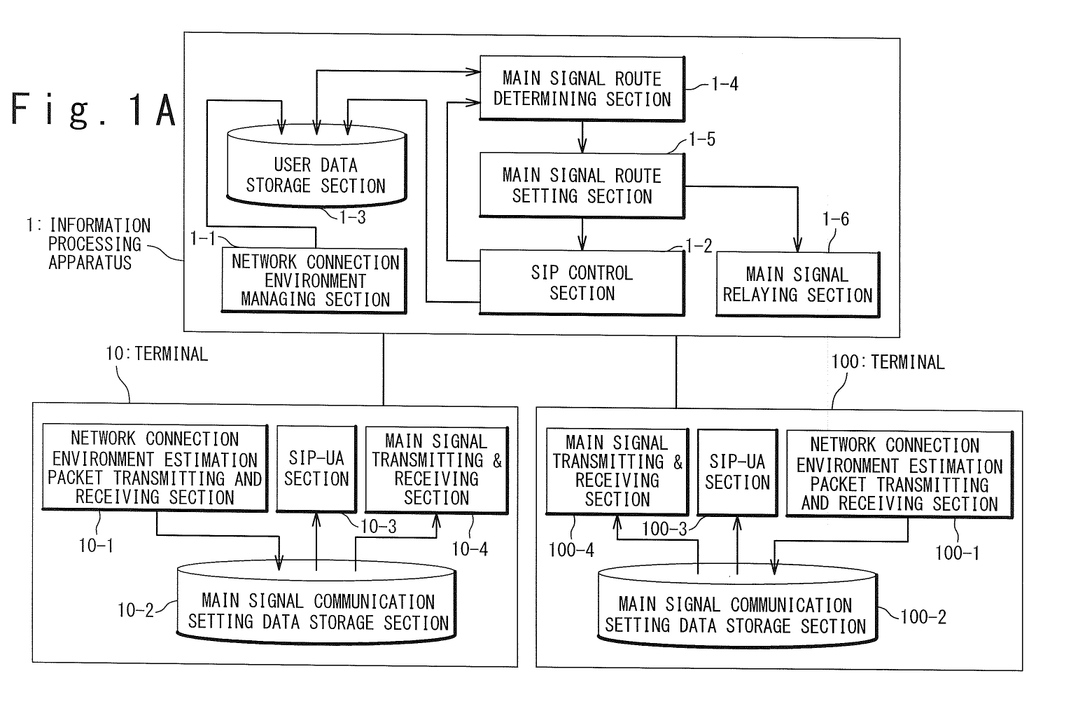

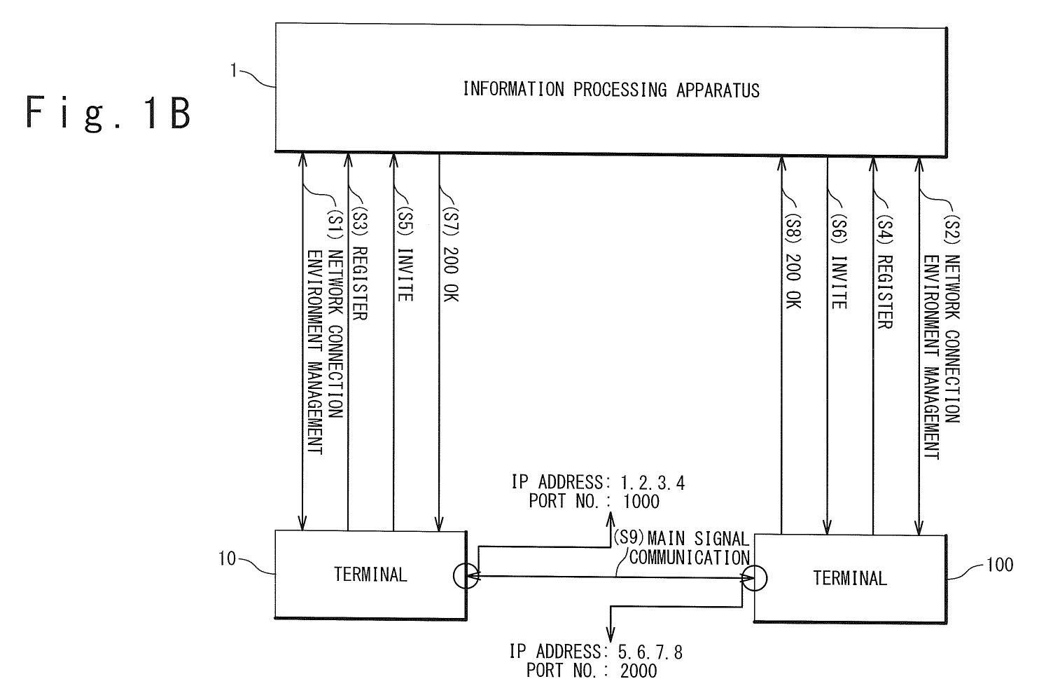

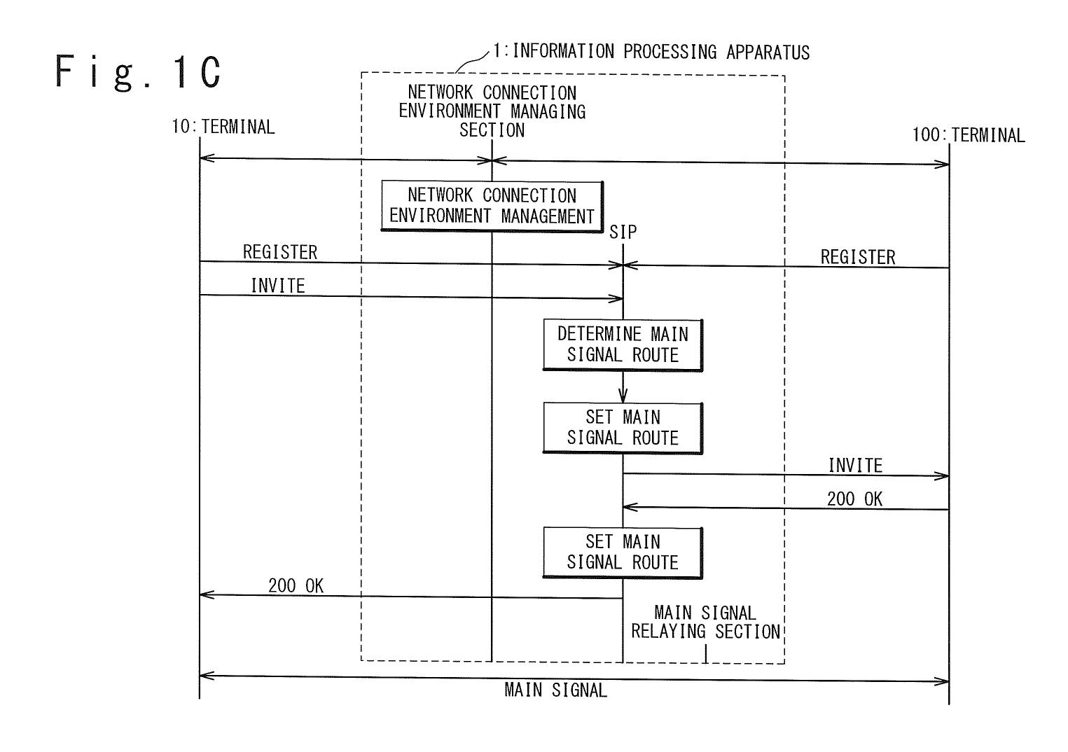

The information processing system according to a first exemplary embodiment of the present invention will be described in detail with reference to FIGS. 1A to 1C. As shown in FIG. 1A, the information processing system according to the first exemplary embodiment of the present invention has an information processing apparatus 1 and terminals 10 and 100.

First, the information processing apparatus 1 will be described. The information processing apparatus 1 includes a network connection environment managing section 1-1, an SIP control section 1-2, a user data storage section 1-3, a main signal route determining section 1-4, a main signal route setting section 1-5, and a main signal relaying section 1-6.

The network connection environment managing section 1-1 manages network connection environment data of the terminals and gives a notice of the main signal communication setting data of the terminal. The SIP control section 1-2 receives an SIP message transmitted from the terminal and performs a control in accordance with a request from the terminal. The user data storage section 1-3 stores a user data and the network connection environment data from the terminal. The main signal route determining section 1-4 determines a main signal route in accordance with the network connection environment data stored in the user data storage section 1-3. The main signal route setting section 1-5 rewrites an SIP message to perform communication through the route determined by the main signal route determining section 1-4. The main signal relaying section 1-6 performs relay based on a data of the main signal route setting section 1-5 when a main signal needs to be relayed.

The above network connection environment data concerns whether or not a terminal is under a NAT (Network Address Translator) apparatus, as well as a type of the NAT apparatus. Also, the network connection environment data shows an IP address and a port number mapped to an IP address and a port number of the terminal to the NAT apparatus when each terminal communicates by traversing the NAT apparatus.

Next, the terminal 10 will be described. The terminal 10 includes a network connection environment estimation packet transmitting and receiving section 10-1, a main signal communication setting data storage section 10-2, and an SIP-UA section 10-3, and a main signal transmitting and receiving section 10-4.

The network connection environment estimation packet transmitting and receiving section 10-1 performs communication in order for the information processing apparatus 1 to recognize network connection environment. The main signal communication setting data storage section 10-2 stores the main signal communication setting data notified by the network connection environment estimation packet transmitting and receiving section 10-1. The SIP-UA section 10-3 performs transmission and reception of an SIP message. The main signal transmitting and receiving section 10-4 performs transmission and reception of a main signal.

It should be noted that the terminal 100 is configured in a same way as the terminal 10. The terminal 100 includes a network connection environment estimation packet transmitting and receiving section 100-1, a main signal communication setting data storage section 100-2, an SIP-UA section 100-3, and a main signal transmitting and receiving section 100-4. The network connection environment estimation packet transmitting and receiving sections 10-1 and 100-1, the main signal communication setting data storage sections 10-2 and 100-2, the SIP-UA sections 10-3 and 100-3, and the main signal transmitting and receiving sections 10-4 and 100-4, each have same functions.

Next, an operation when the terminals 10 and 100 perform the main signal communication will be described in accordance with the respective network connection environment data of the terminals.

An operation of the information processing system will be described in the following cases: (A) a case that there is no NAT apparatus, (B) a case that only one terminal is under a NAT apparatus, and (C) a case that both the terminals are under a NAT apparatus or NAT apparatuses. Particularly, the case that only one terminal is under a NAT apparatus will be divided separately and described as a case that the NAT apparatus is a Cone-type NAT apparatus and a case that the NAT apparatus is a Symmetric NAT apparatus. The case that both the terminals are under a NAT apparatus or NAT apparatuses will be separately divided and described as a case that the terminals are under a Cone-type NAT apparatus and a Symmetric NAT apparatus, and a case that both the terminals are under a same NAT apparatus.

### (A) Case of No NAT Apparatus

The Operation of the system will be described with reference to FIGS. 1A to 1C.

### <Operation of Network Connection Environment Management>

The terminal 10 transmits a network connection environment estimation packet from the network connection environment estimation packet transmitting and receiving section 10-1 to the network connection environment managing section 1-1 of the information processing apparatus 1, in order to acquire an IP address and a port number used in the main signal communication, before the main signal communication. The network connection environment managing section 1-1 receives the packet, and requests the terminal 10 to iteratively transmit packets, in order to recognize a type of the NAT apparatus under which the terminal 10 is, and recognize whether the terminal 10 is not under any NAT apparatus. More specifically, the network connection environment managing section 1-1 requests transmission of the packets from different port numbers to the network connection environment estimation packet transmitting and receiving section 10-1 of the terminal 10. The network connection environment estimation packet transmitting and receiving section 10-1 performs packet transmission in response to the request. The network connection environment managing section 1-1 acquires network connection environment data of the terminal 10, and then stores the network connection environment data in the user data storage section 1-3 of the information processing apparatus 1, and notifies an IP address and a port number for the main signal communication to the terminal 10. In this case, as shown in FIG. 1B, since the terminals 10 and 100 are not under a NAT apparatus, an IP address and a port number for the main signal communication of the terminal 10 are “1. 2. 3. 4” and “No. 1000”, respectively. The IP address and the port number for the main signal communication of the terminal 100 are “5. 6. 7. 8” and “No. 2000”, respectively. The notified data is stored in the main signal communication setting data storage section 10-4. The terminal 100 performs the same operation as the terminal 10.

It should be noted that as the operation for recognition and acquisition of the network connection environment, it is possible to use a method of a STUN system described in the first related art and methods described in the second and fourth related arts. Also, a method may be used in which communication between the information processing apparatus 1 and the terminal 10, and the information processing apparatus 1 and the terminal 100 is performed, or it is possible to use a method of obtaining data from network administrators concerning a type of a NAT apparatus and the presence of a NAT apparatus.

### <Operation of SIP REGISTER>

The terminal 10 transmits a REGISTER message from the SIP-UA section 10-3 to the information processing apparatus 1 in order to perform SIP communication. The SIP control section 1-2 receives the REGISTER message and stores a data contained in the REGISTER message in the user data storage section 1-3. At this time, the information processing apparatus 1 associates user data from the terminal 10 with the network connection environment data.

In the above description, the operation of acquiring the network connection environment data is first performed, followed by the SIP REGISTER operation. However, this order may be reversed.

<SIP sequence (from INVITE to 200 OK)>

Exchange of SIP messages will be described in which the communication is started from the terminal 10. The SIP-UA section 10-3 of the terminal 10 transmits an INVITE message destined to the terminal 100 through the information processing apparatus 1. The IP address of “1. 2. 3. 4” and the port number of “No. 1000”, have been written in a main signal communication setting section of the message. The SIP control section 1-2 of the information processing apparatus 1 receives the INVITE message destined to the terminal 100, and then notifies a data indicating that communication will be performed between the terminals 10 and 100, to the main signal route determining section 1-4, in order to determine a route of the main signal communication. The main signal route determining section 1-4 inquires the network connection environment data of the terminals 10 and 100 to the user data storage section 1-3, to acquire the network connection environment data, and determines the main signal communication route from the acquired network connection environment data. In FIG. 1B, since the terminals 10 and 100 are not under a NAT apparatus, the terminals 10 and 100 are judged to be possible for direct communication to be performed, and a data indicating that the direct communication is possible is notified to the main signal route setting section 1-5. The main signal route setting section 1-5 notifies to the SIP control section 1-2, that no change will be made to a main signal standby IP address and a port number in the INVITE message transmitted from the terminal 10. The main signal route setting section 1-5 also notifies to the main signal relaying section 1-6, that main signal relay is not performed. After that, the SIP control section 1-2 transmits the INVITE message to the terminal 100. The terminal 100 receives the INVITE message, and then transmits a reply (200 OK) message to the SIP control section 1-2 of the information processing apparatus 1. The IP address of “5. 6. 7. 8” and the port number of “No. 2000”, have been written in a main signal communication setting section of the replay message. The SIP control section 1-2 forwards the reply (200 OK) message transmitted from the terminal 100 to the terminal 10. The procedure before the start of the main signal communication is completed here.

### <Main Signal Communication>

The terminal 10 performs the main signal communication by using the standby IP address of “1. 2. 3. 4”, and the port number of “No. 1000” for the main signal communication, and setting the IP address of “5. 6. 7. 8” and the port number of “No. 2000”, written in the reply (200 OK) message received from the terminal 100 through the SIP control section 1-2 of the information processing apparatus 1 as a destination IP address and a destination port number for the main signal communication. The terminal 100 performs the main signal communication by using the standby IP address of “5. 6. 7. 8” and the port number of “No. 2000”, for the main signal communication, and the IP address of “1. 2. 3. 4” and the port number of “No. 1000” for the main signal communication written in the INVITE message received from the terminal 10 through the SIP control section 1-2 of the information processing apparatus 1 as a destination IP address and a destination port number for the main signal communication.

### (B) Case of a NAT Apparatus on One Side

### 1. Case of a Cone-Type NAT Apparatus

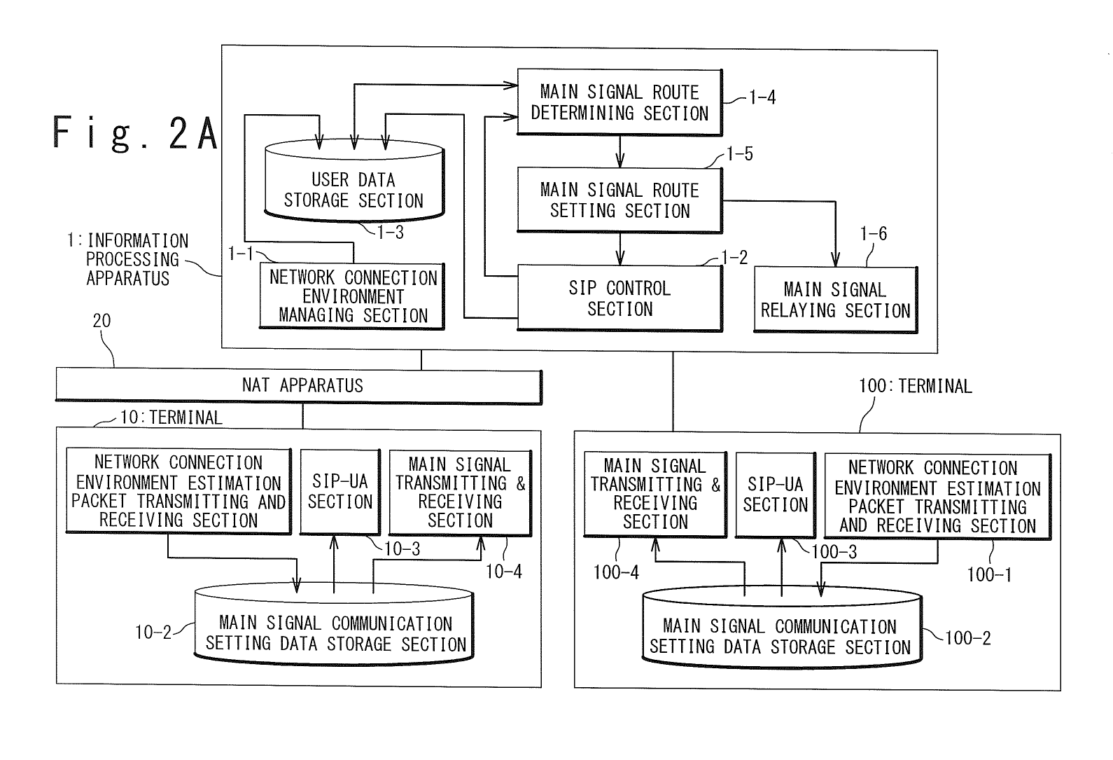

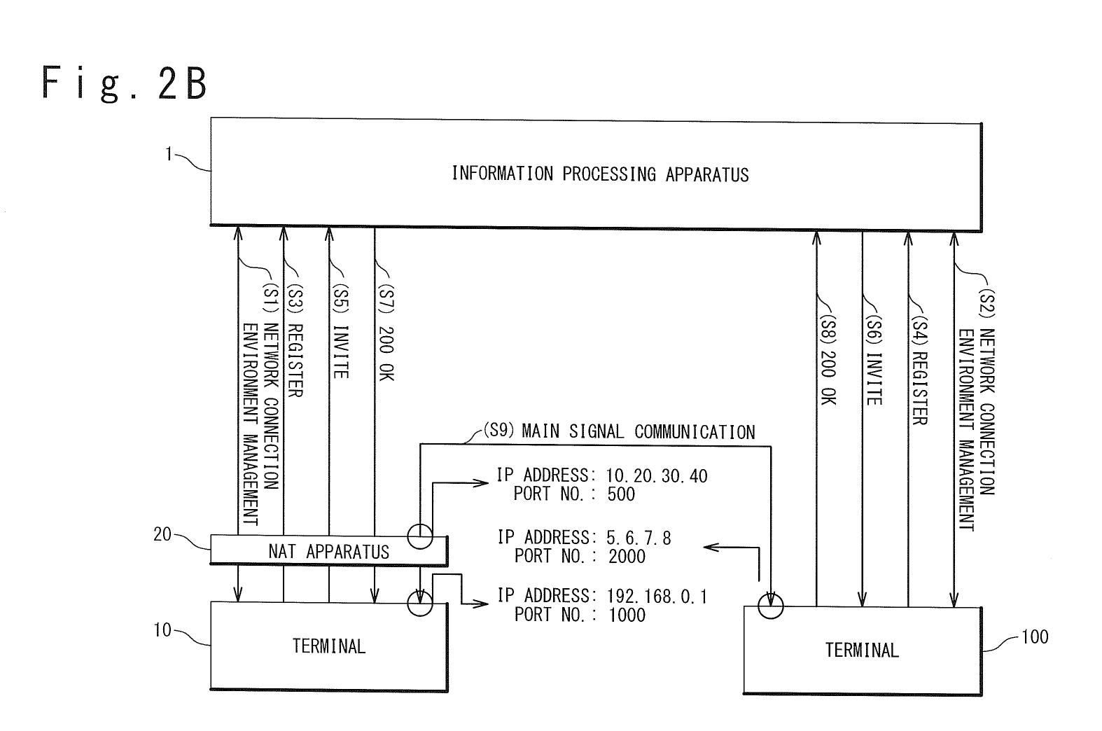

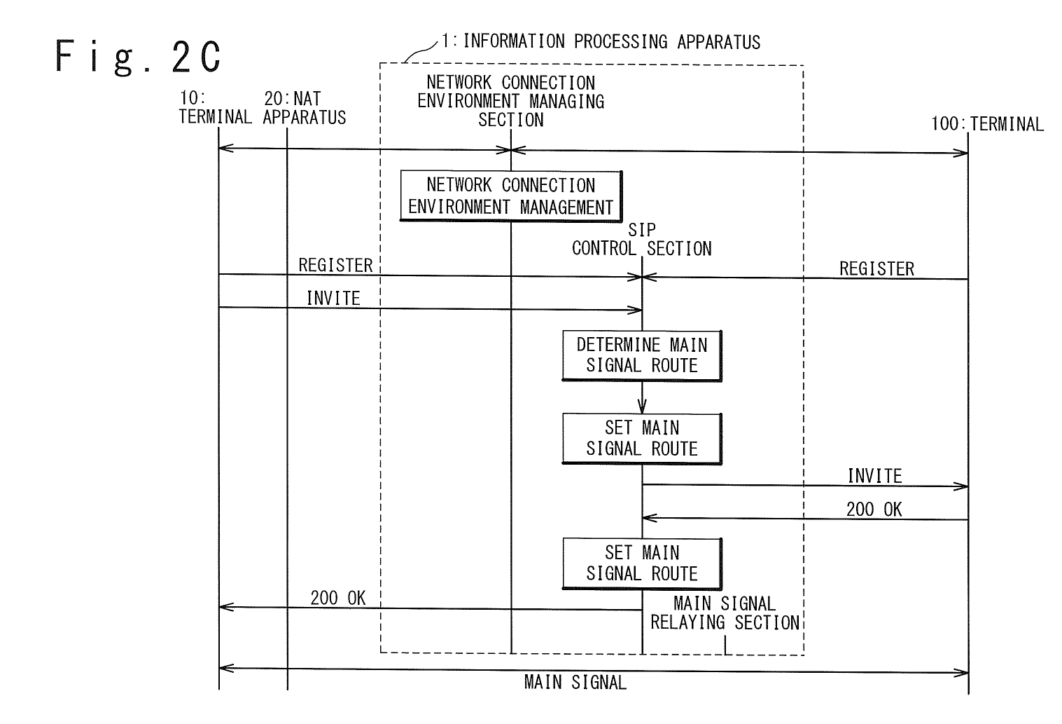

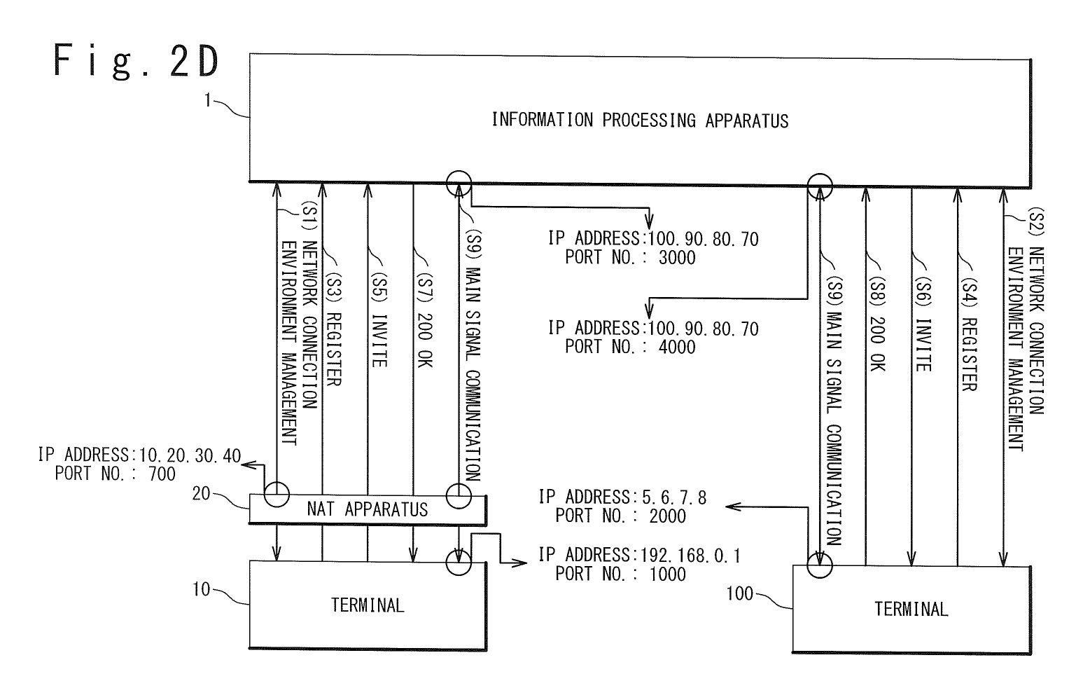

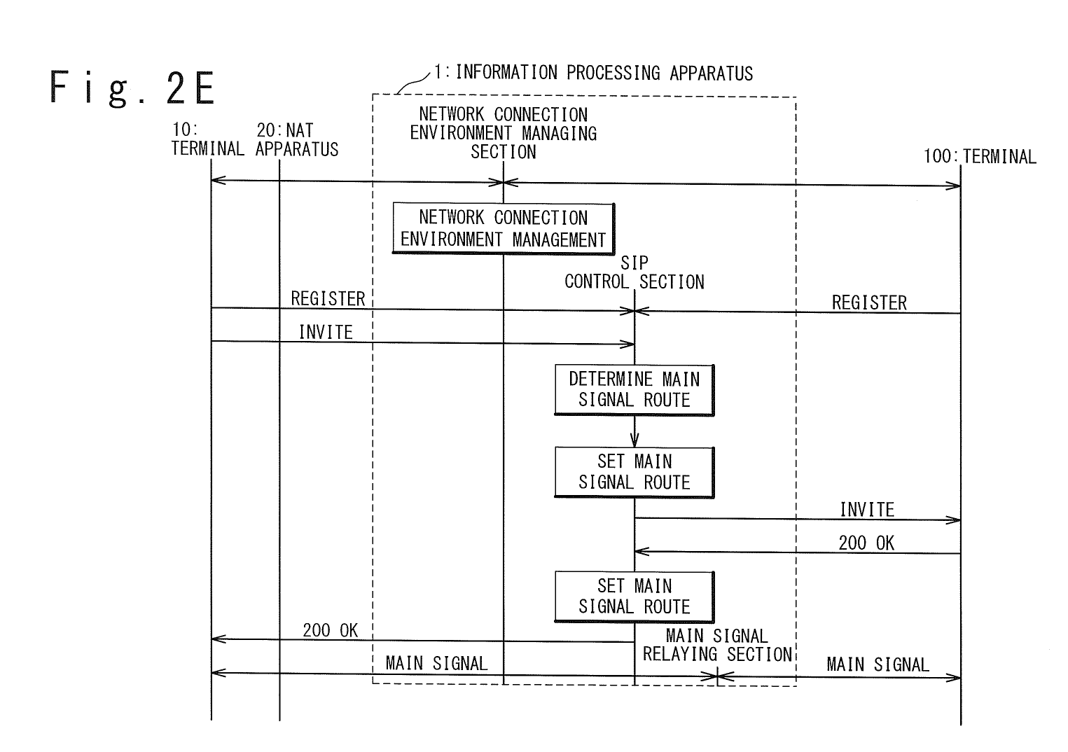

The operation of the system will be described with reference to FIGS. 2A, 2B, and 2C.

### <Operation of Network Connection Environment Management>

The recognition and acquisition of the network connection environment has already been described in “(A) Case of no NAT apparatus”. Accordingly, the difference will be described here. The terminal 10 is under a Cone-type NAT apparatus. In the NAT apparatus 20, it is supposed that the IP address of “10. 20. 30. 40” and the port number of “No. 500” are mapped to the IP address of “192. 168. 0. 1” and the port number of “No. 1000”. The terminal 10 notifies the IP address of “192. 168. 0. 1”, and the port number of “No. 1000” to the network connection environment managing section 1-1 as a header data of a packet produced to perform network connection environment estimation. The network connection environment managing section 1-1 acquires a data indicating that the terminal 10 is under a Cone-type NAT apparatus, and the IP address of “10. 20. 30. 40”, and the port number of “No. 500” for the terminal 10 to perform the main signal communication through the NAT apparatus 20. The acquired data is stored in the user data storage section 1-3. The network connection environment managing section 1-1 notifies the IP address of “10. 20. 30. 40” and the port number of “No. 500” for the main signal communication to the network connection environment estimation packet transmitting and receiving section 10-1 of the terminal 10.

### <Operation of SIP REGISTER>

An SIP REGISTER operation is the same as one when the network connection environment is “(A) Case of no NAT apparatus”, and will not be described here. In the above description, the operation for the recognition and acquisition of the network connection environment is first performed, followed by the SIP REGISTER operation. However, this order may be reversed.

<SIP Sequence (from INVITE to 200 OK)>

Exchange of SIP messages will be described in which the communication is started from the terminal 10. The SIP-UA section 10-3 of the terminal 10 transmits an INVITE message destined to the terminal 100 through the information processing apparatus 1. The IP address of “10. 20. 30. 40” and the port number of “No. 500” have been written in a main signal communication setting section of the INVITE message. The SIP control section 1-2 of the information processing apparatus 1 receives the INVITE message destined to the terminal 100, and notifies a data indicating that communication will be performed between the terminals 10 and 100, to the main signal route determining section 1-4. The main signal route determining section 1-4 then inquires network connection environment data of the terminals 10 and 100 to the user data storage section 1-3 to obtain the data and determines a route of main signal communication from the network connection environment data of the terminals 10 and 100. The main signal communication between the terminals 10 and 100 through the NAT apparatus 20 is judged to be possible since the terminal 10 is under a Cone-type NAT apparatus 20 and the terminal 100 is not under a NAT apparatus, and the data concerning the judgment is notified to the main signal communication route setting section 1-5. The communication route is shown in FIG. 2B. The main signal route setting section 1-5 refers to a main signal standby IP address and a port number in the INVITE message transmitted from the terminal 10 to confirm that the IP address and the port number are “10. 20. 30. 40” and “No. 500”, respectively, and notifies to the SIP control section 1-2 that the IP address and the port number for the main signal communication in the INVITE message should not be rewritten. The main signal route setting section 1-5 notifies to the main signal relaying section 1-6 that main signal relay is not performed. After that, the SIP control section 1-2 transmits the INVITE message to the terminal 100. The terminal 100 receives the INVITE message, and transmits a reply (200 OK) message to the SIP control section 1-2 of the information processing apparatus 1. The IP address of “5. 6. 7. 8” and the port number of “No. 2000” are written in the main signal communication setting section of the message. The SIP control section 1-2 forwards the reply (200 OK) message transmitted from the terminal 100 to the terminal 10. The procedure before start of the main signal communication is completed here.

### <Main Signal Communication>

The terminal 10 performs the main signal communication by setting the standby IP address of “192. 168. 0. 1” and the port number of “No. 1000” for the main signal communication, and the IP address of “5. 6. 7. 8” and the port number of “No. 2000” for the main signal communication written in the reply (200 OK) message from the terminal 100, which is received from the SIP control section 1-2 of the information processing apparatus 1 as a destination IP address and a destination port number for the main signal communication. The terminal 100 performs the main signal communication by setting the standby IP address of “5. 6. 7. 8” and the port number of “No. 2000” for the main signal communication, and the IP address of “10. 20. 30. 40” and the port number of “No. 500” for the main signal communication written in the INVITE message from the terminal 10, which is received from the SIP control section 1-2 of the information processing apparatus 1.

### 2. Case of Symmetric NAT Apparatus

The operation of the system will be described with reference to FIGS. 2A, 2D, and 2E.

### <Operation of Network Connection Environment Management>

The recognition and acquisition of network connection environment has already been described in “(A) Case of no NAT apparatus” and “(B) Case of a NAT apparatus on one side”. Accordingly, the difference therebetween will be described here. The terminal 10 is under a Symmetric NAT apparatus. In the operation of network connection environment management performed between the network connection environment estimation packet transmitting and receiving section 10-1 of the terminal 10 and the network connection environment managing section 1-1 of the information processing apparatus 1, the network connection environment managing section 1-1 of the information processing apparatus 1, after recognizing that the terminal 10 is under the Symmetric NAT apparatus, acquires the IP address of “10. 20. 30, 40” and the port number of “No. 700” for the terminal 10 mapped to the NAT apparatus 20. The acquired data is stored in the user data storage section 1-3. The network connection environment managing section 1-1 notifies the IP address of “10. 20. 30. 40” and the port number of “No. 700” for the main signal communication to the network connection environment estimation packet transmitting and receiving section 10-1 of the terminal 10.

### <Operation of SIP REGISTER>

The SIP REGISTER operation is the same as one when the network connection environment is “(A) Case of no NAT apparatus”, and will not be described here.

In the above description, the operation of network connection environment recognition and acquisition is performed first followed by the SIP REGISTER operation. However, this order may be reversed.

<SIP Sequence (from INVITE to 200 OK)>

Exchange of SIP messages will be described in which the communication is started from the terminal 10. The SIP-UA section 10-3 of the terminal 10 transmits an INVITE message destined to the terminal 100 to the information processing apparatus 1. The IP address of “10. 20. 30. 40” and the port number of “No. 700”, have been written in a main signal communication setting section of the INVITE message. The SIP control section 1-2 of the information processing apparatus 1 receives the INVITE message destined to the terminal 100, and then notifies to the main signal route determining section 1-4 that communication will be performed between the terminals 10 and 100 in order to determine a route of the main signal communication. The main signal route determining section 1-4 inquires the network connection environment data of the terminals 10 and 100 to the user data storage section 1-3 to acquire the network connection environment data and determines the main signal communication route from the network connection environment data of the terminals 10 and 100. It is judged that the main signal communication between the terminals 10 and 100 must be performed through the information processing apparatus 1 since the terminal 10 is under the Symmetric NAT apparatus and the terminal 100 is not under a NAT apparatus, and the data concerning the judgment is notified to the main signal route setting section 1-5. The communication route is shown in FIG. 2D. The main signal route setting section 1-5 refers to the main signal standby IP address and the port number in the INVITE message transmitted from the terminal 10 to confirm that the IP address and the port number are set to “10. 20. 30. 40” and “No. 700”, respectively, and rewrites the IP address and the port number to “100. 90. 80. 70” and “No. 4000”, respectively, in order to relay a main signal from the terminal 100, in the information processing apparatus 1. The main signal route setting section 1-5 notifies the main signal relaying section 1-6 of the data that a main signal is relayed and the IP address of “100. 90. 80. 70” and the port number of “No. 4000”, which have been rewritten in order to perform the main signal communication between the terminal 100 and the information processing apparatus 1. After that, the SIP control section 1-2 transmits a rewritten INVITE message to the terminal 100. The terminal 100 receives the INVITE message, and then transmits a reply (200 OK) message to the SIP control section 1-2 of the information processing apparatus 1. The IP address of “5. 6. 7. 8” and the port number of “No. 2000” haven been written in the main signal communication setting section of the replay message. The SIP control section 1-2 receives the reply (200 OK) message from the terminal 100, and then notifies the reception to the main signal route determining section 1-4. The route determined when the INVITE message has been transmitted from the terminal 10 in the above description, is notified to the main signal route setting section 1-5. The main signal route setting section 1-5 refers to the main signal standby IP address and the port number in the reply (200 OK) message to confirm that the IP address and the port number are set to “5. 6. 7. 8” and “No. 2000”, respectively, and rewrites the IP address and the port number to “100. 90. 80. 70” and “No. 3000”, respectively, in order to relay the main signal from the terminal 100 in the information processing apparatus 1. The main signal route setting section 1-5 also notifies the IP address of “100. 90. 80. 70” and the port number of “No. 3000”, which have been rewritten, to the main signal relaying section 1-6 to perform the main signal communication between the terminal 10 and the information processing apparatus 1. After that, the SIP control section 1-2 transmits the rewritten reply (200 OK) message to the terminal 10. The procedure before the start of the main signal communication is completed here.

### <Main Signal Communication>

The terminal 10 performs the main signal communication by setting the standby IP address of “192. 168. 0. 1” and the port number of “No. 1000” for the main signal communication, and the IP address of “100. 90. 80. 70” and the port number of “No. 3000” for the main signal communication written in the reply (200 OK) message from the terminal 100, which are received from the SIP control section 1-2 of the information processing apparatus 1 as the destination IP address and the port number for the main signal communication. The terminal 100 performs the main signal communication by setting the standby IP address of “5. 6. 7. 8” and the port number of “No. 2000” for the main signal communication, and the IP address of “100. 90. 80. 70” and the port number of “No. 4000” for the main signal communication written in the INVITE message from the terminal 10, which are received from the SIP control section 1-2 of the information processing apparatus 1 as the destination IP address and the port number for the main signal communication.

### (C) Case of NAT Apparatuses on Both Sides

### 1. Case of a Cone-Type NAT Apparatus and a Cone-Type NAT Apparatus

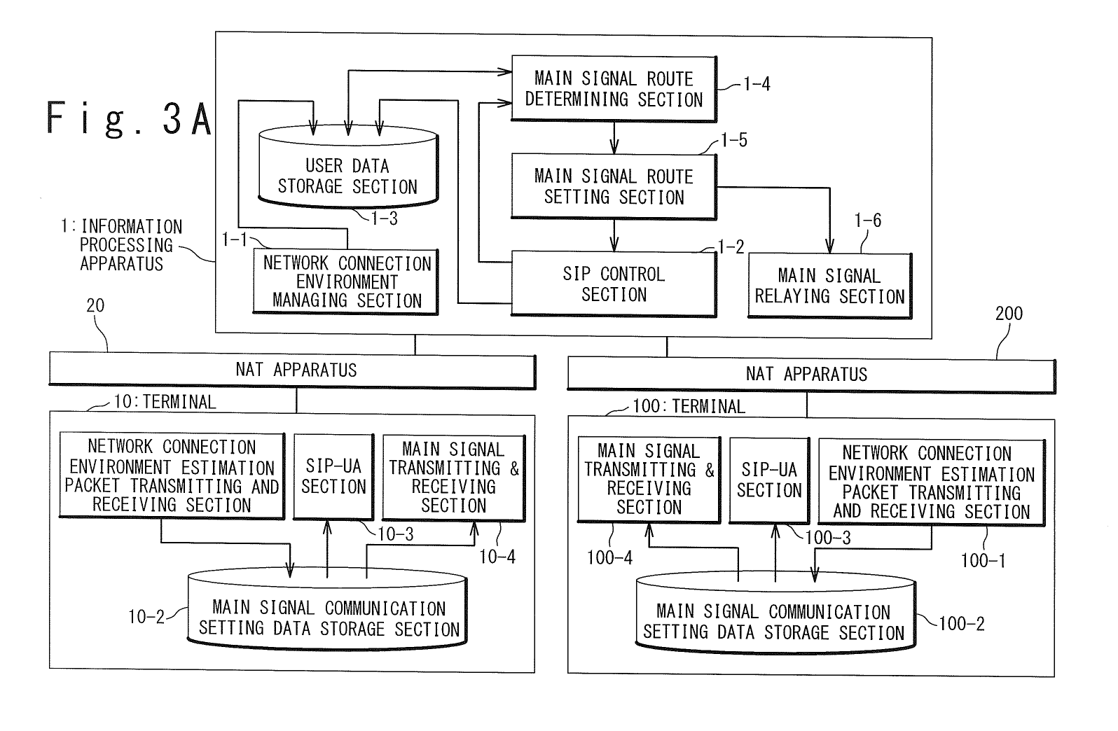

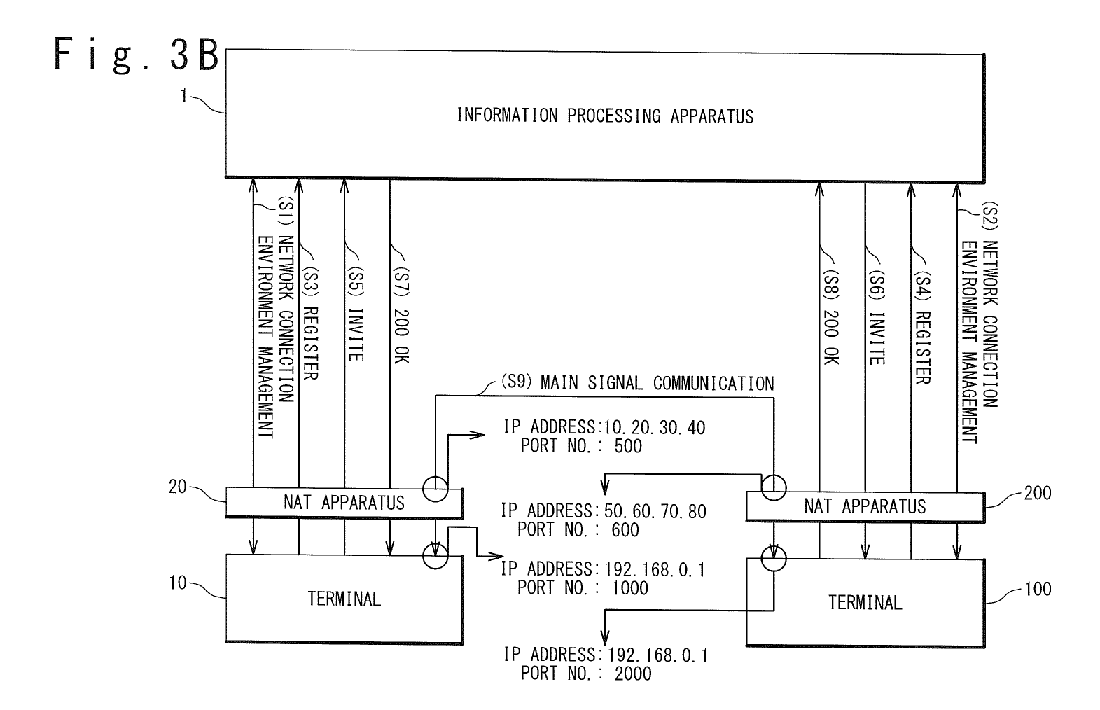

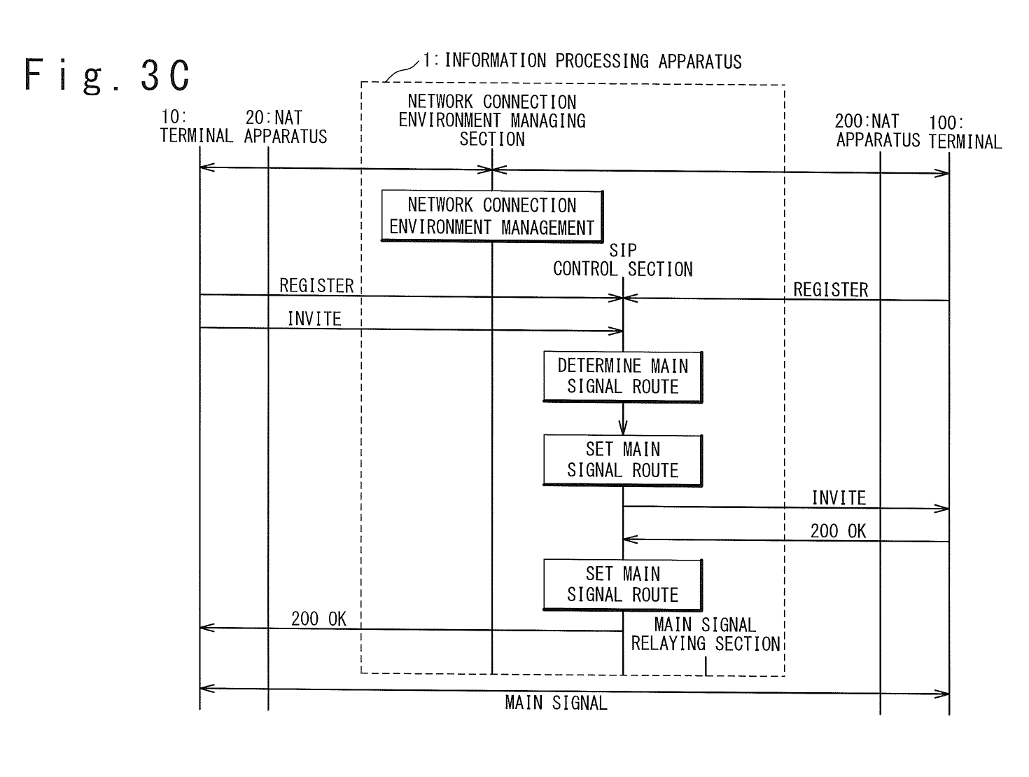

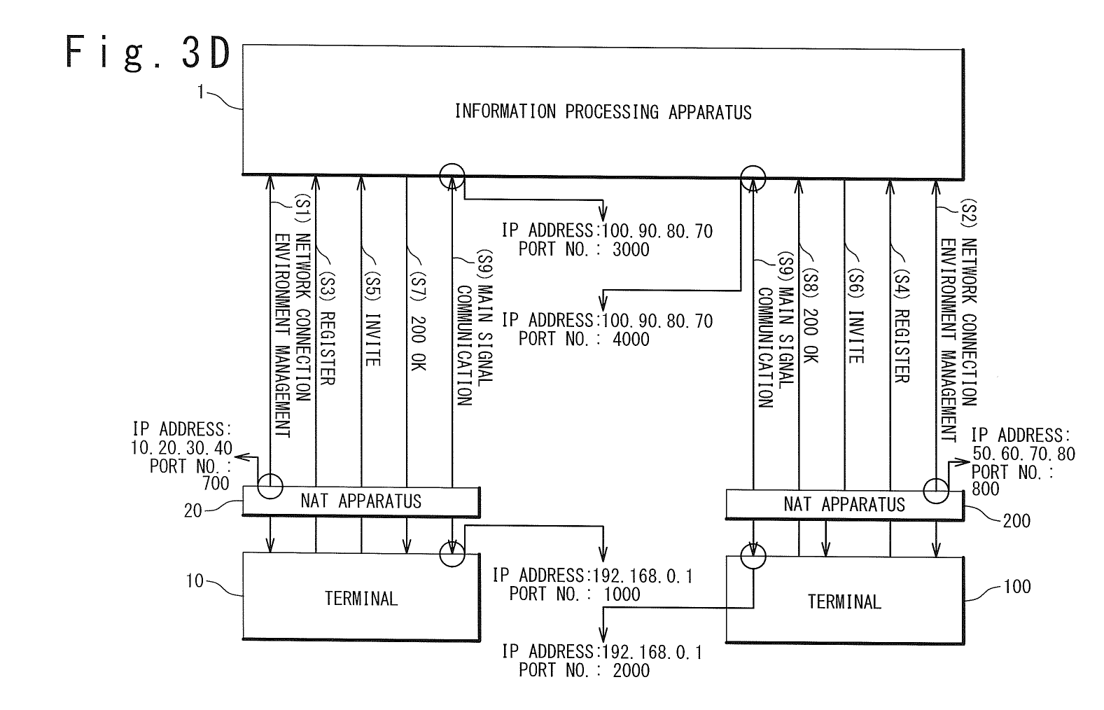

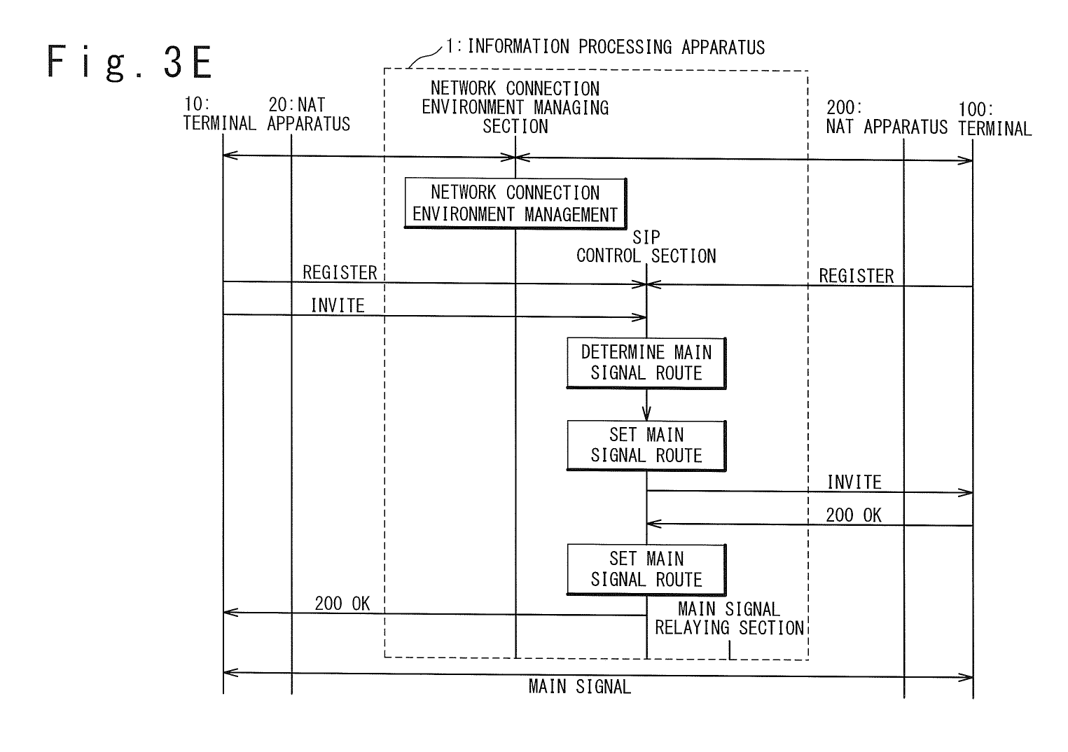

The operation of the system will be described with reference to FIGS. 3A, 3B, and 3C.

### <Operation of Network Connection Environment Management>

The recognition and acquisition of network connection environment have already been described in “(A) Case of no NAT apparatus” and “(B) Case of a NAT apparatus on one side, and accordingly the difference therebetween will be described here. In the network connection environment managing section 1-1 of the information processing apparatus 1, the terminals 10 and 100 are connected to Cone-type NAT apparatuses. The network connection environment data of the terminal 10 concerning the connection to a Cone-type NAT apparatus, and the IP address of “10. 20. 30. 40” and the port number of “No. 500” for the main signal communication are obtained, which are then stored in the user data storage section 1-3. The network connection environment managing section 1-1 notifies the IP address of “10. 20. 30. 40” and the port number of “No. 500” for the main signal communication to the terminal 10. The network connection environment estimation packet transmitting and receiving section 10-1 of the terminal 10 receives the notification of the IP address and port number for the main signal communication, and then stores the IP address and the port number in the main signal communication setting data storage section 10-2. For the terminal 100 as well, the network connection environment data of the terminal 100 concerning the connection to a Cone-type NAT apparatus, and the port number of “50. 60. 70. 80” and port number of “No. 600” for the main signal communication are acquired, which are then stored in the user data storage section 1-3. The network connection environment managing section 1-1 notifies the IP address of “50. 60. 70. 80” and the port number of “No. 600” for the main signal communication to the terminal 100. The network connection environment estimation packet transmitting and receiving section 100-1 of the terminal 100 receives the notification of the IP address and port number for the main signal communication, and then stores the IP address and the port number in the main signal communication setting data storage section 100-2.

### <Operation of SIP REGISTER>

The SIP REGISTER operation is the same as one when the network connection environment is “(A) Case of no NAT apparatus”, and will not be described here. In the above description, the operation of network connection environment management is performed first followed by the SIP REGISTER operation. However, this order may be reversed.

<SIP Sequence (from INVITE to 200 OK)>

Exchange of SIP messages will be described in which the communication is started from the terminal 10. The SIP-UA section 10-3 of the terminal 10 transmits an INVITE message destined to the terminal 100, to the information processing apparatus 1. The IP address of “10. 20. 30. 40” and the port number of “No. 500” are written in a main signal communication setting section of the message. The SIP control section 1-2 of the information processing apparatus 1 receives the INVITE message destined to the terminal 100, and then notifies a data indicating that communication will be performed between the terminals 10 and 100 to the main signal route determining section 1-4 in order to determine a route of the main signal communication. The main signal route determining section 1-4 inquires the network connection environment data of the terminals 10 and 100 to the user data storage section 1-3 to obtain it, and determines the route from the network connection environment data of the terminals 10 and 100. It is judged that the main signal communication between the terminals 10 and 100 is possible through NAT apparatuses 20 and 200 since the terminals 10 and 100 are both under Cone-type NAT apparatuses, and the data concerning the judgment is notified to the main signal route setting section 1-5. The communication route is shown in FIG. 3B. The main signal route setting section 1-5 refers to the main signal standby IP address and the port number in the INVITE message transmitted from the terminal 10 to confirm that the IP address and the port number are set to “10. 20. 30. 40” and “No. 500”, respectively, and then notifies to the SIP control section 1-2 that no change will be made in the IP address and the port number. The main signal route setting section 1-5 also notifies to the main signal relaying section 1-6 that main signal relay is not performed. After that, the SIP control section 1-2 transmits the INVITE message to the terminal 100. The terminal 100 receives the INVITE message, and transmits a reply (200 OK) message to the SIP control section 1-2 of the information processing apparatus 1. The IP address of “50. 60. 70. 80” and the port number of “No. 700” have been written in the main signal communication setting section of the message. The SIP control section 1-2 forwards the reply (200 OK) message from the terminal 100, to the terminal 10. The procedure before the start of the main signal communication is completed here.

### <Main Signal Communication>

The terminal 10 performs the main signal communication by setting the standby IP address of “192. 168. 0. 1” and the port number of “No. 1000” for the main signal communication, and the IP address of “50. 60. 70. 80” and the port number of “No. 700” for the main signal communication written in the reply (200 OK) message received from the terminal 100 through the SIP control section 1-2 of the information processing apparatus 1 as the destination IP address and the port number for the main signal communication. The terminal 100 performs the main signal communication by setting a standby IP address of “5. 6. 7. 8” and the port number of “No. 2000” for the main signal communication, and the IP address of “10. 20. 30. 40” and the port number of “No. 500” for the main signal communication written in the INVITE message received from the terminal 10 through the SIP control section 1-2 of the information processing apparatus 1 as the destination IP address and the port number for the main signal communication.

### 2. Case of a Cone-Type NAT Apparatus and a Symmetric NAT Apparatus

The operation of the system will be described with reference to FIGS. 3A, 3D, and 3E.

### <Operation of Network Connection Environment Management>

The recognition and acquisition of network connection environment have already been described in “(A) Case of no NAT apparatus” and “(B) Case of a NAT apparatus on one side. Accordingly, the difference therebetween will be described here. The terminals 10 and 100 are under a Cone-type NAT apparatus and a Symmetric NAT apparatus, respectively. In the operation of network connection environment management performed between the network connection environment estimation packet transmitting and receiving section 10-1 of the terminal 10 and the network connection environment managing section 1-1 of the information processing apparatus 1, when recognizing that the terminal 10 is under a Cone-type NAT apparatus, the network connection environment managing section 1-1 of the information processing apparatus 1 acquires a data indicating that the terminal 10 is under a Cone-type NAT apparatus, and the IP address of “10. 20. 30. 40” and the port number of “No. 700” mapped to the NAT apparatus 20 for the terminal 10 to communicate through the NAT apparatus 20. The obtained data is stored in the user data storage section 1-3. The network connection environment managing section 1-1 notifies the IP address of “10. 20. 30. 40” and the port number of “No. 700” mapped to the NAT apparatus 20 to the network connection environment estimation packet transmitting and receiving section 10-1 of the terminal 10. The network connection environment estimation packet transmitting and receiving section 10-1 of the terminal 10 stores the notified IP address and port number in the main signal communication setting data storage section 10-2. In the terminal 100 as well, the network connection environment managing section 1-1 obtains a data indicating that the terminal 100 is under a Symmetric NAT apparatus, and the IP address of “50. 60. 70. 80” and the port number of “No. 800” mapped to the NAT apparatus 200 for the terminal 100 to perform communication through the NAT apparatus 200. The obtained data is stored in the user data storage section 1-3. The network connection environment managing section 1-1 notifies the IP address of “50. 60. 70. 80” and the port number of “No. 800” mapped to the NAT apparatus 200 to the network connection environment estimation packet transmitting and receiving section 100-1 of the terminal 100. The network connection environment estimation packet transmitting and receiving section 100-1 of the terminal 100 stores the notified IP address and port number in the main signal communication setting data storage section 100-2.

### <Operation of SIP REGISTER>

The SIP REGISTER operation is the same as one when the network connection environment is “(A) Case of no NAT apparatus” and will not be described here. In the above description, the operation of network connection environment management is performed first followed by the SIP REGISTER operation. However, this order may be reversed.

<SIP sequence (from INVITE to 200 OK)>

Exchange of SIP messages will be described in which the communication is started from the terminal 10. The SIP-UA section 10-3 of the terminal 10 transmits an INVITE message destined to the terminal 100, to the information processing apparatus 1. The IP address of “10. 20. 30. 40” and the port number of “No. 700” have been written in a main signal communication setting section of the message. The SIP control section 1-2 of the information processing apparatus 1 receives the INVITE message destined to the terminal 100, and then notifies a data indicating that communication will be performed between the terminals 10 and 100, to the main signal route determining section 1-4 in order to determine a route of the main signal communication. The main signal route determining section 1-4 then inquires the network connection environment data of the terminals 10 and 100 to the user data storage section 1-3 to acquire it, and determines the route from the network connection environment data of the terminals 10 and 100. It is judged that the main signal communication between the terminals 10 and 100 must be performed through the information processing apparatus 1 since the terminals 10 and 100 are under the Cone-type NAT apparatus and the Symmetric NAT apparatus, respectively, and the data concerning the judgment is notified to the main signal route setting section 1-5. The communication route is shown in FIG. 3B. The main signal route setting section 1-5 refers to a main signal standby IP address and a port number in the INVITE message transmitted from the terminal 10 to confirm that the IP address and the port number are set to “10. 20. 30. 40” and “No. 700”, respectively. The main signal route setting section 1-5 also rewrites the IP address and the port number to “100. 90. 80. 70” and “No. 4000”, respectively, to relay a main signal from the terminal 100 in the information processing apparatus 1. The main signal route setting section 1-5 also notifies a data indicating that a main signal is relayed, and the IP address of “100. 90. 80. 70” and the port number of “No. 4000”, which have been rewritten above, to the main signal relaying section 1-6, to perform the main signal communication between the terminal 100 and the information processing apparatus 1. After that, the SIP control section 1-2 transmits the rewritten INVITE message to the terminal 100. The terminal 100, after receiving the INVITE message, transmits a reply (200 OK) message to the SIP control section 1-2 of the information processing apparatus 1. The IP address of “50. 60. 70. 80” and the port number of “No. 800” are written in a main signal communication setting section of the message. The SIP control section 1-2 receives the reply (200 OK) message from the terminal 100, and then notifies the reception to the main signal route determining section 1-4. The route determined when the INVITE message has been transmitted from the terminal 10, is notified to the main signal route setting section 1-5. The main signal route setting section 1-5 refers to the main signal standby IP address and the port number in the reply (200 OK) message to confirm that the IP address and the port number are set to “50. 60. 70. 80” and “No. 800”, respectively, and rewrites the IP address and the port number to “100. 90. 80. 70” and “No. 3000”, respectively, to relay a main signal from the terminal 100 in the information processing apparatus 1. The main signal route setting section 1-5 notifies the IP address of “100. 90. 80. 70” and the port number of “No. 3000”, which have been rewritten above, to the main signal relaying section 1-6, to perform the main signal communication between the terminal 10 and the information processing apparatus 1. After that, the SIP control section 1-2 transmits the rewritten reply (200 OK) message to the terminal 100. The procedure before the start of the main signal communication is completed here.

### <Main Signal Communication>

The terminal 10 performs the main signal communication by setting the standby IP address of “192. 168. 0. 1” and the port number of “No. 1000” for the main signal communication, and the IP address of “100. 90. 80. 70” and the port number of “No. 3000” for the main signal communication written in the reply (200 OK) message received from the terminal 100 through the SIP control section 1-2 of the information processing apparatus 1 as the destination IP address and the port number for the main signal communication. The terminal 100 performs the main signal communication by setting the standby IP address of “100. 90. 80. 70” and the port number of “No. 4000” for the main signal communication, and the IP address of “100. 90. 80. 70” and the port number of “No. 4000” for the main signal communication written in the INVITE message destined from the terminal 10 from the SIP control section 1-2 of the information processing apparatus 1 as the destination IP address and the port number for the main signal communication.

### 3. Case of a Symmetric NAT Apparatus and a Symmetric NAT Apparatus

This case is the same as the case where terminals for the main signal communication are both under Cone-type NAT apparatus(es), and will not be described any more.

4. Case of Connection to the same NAT Apparatus

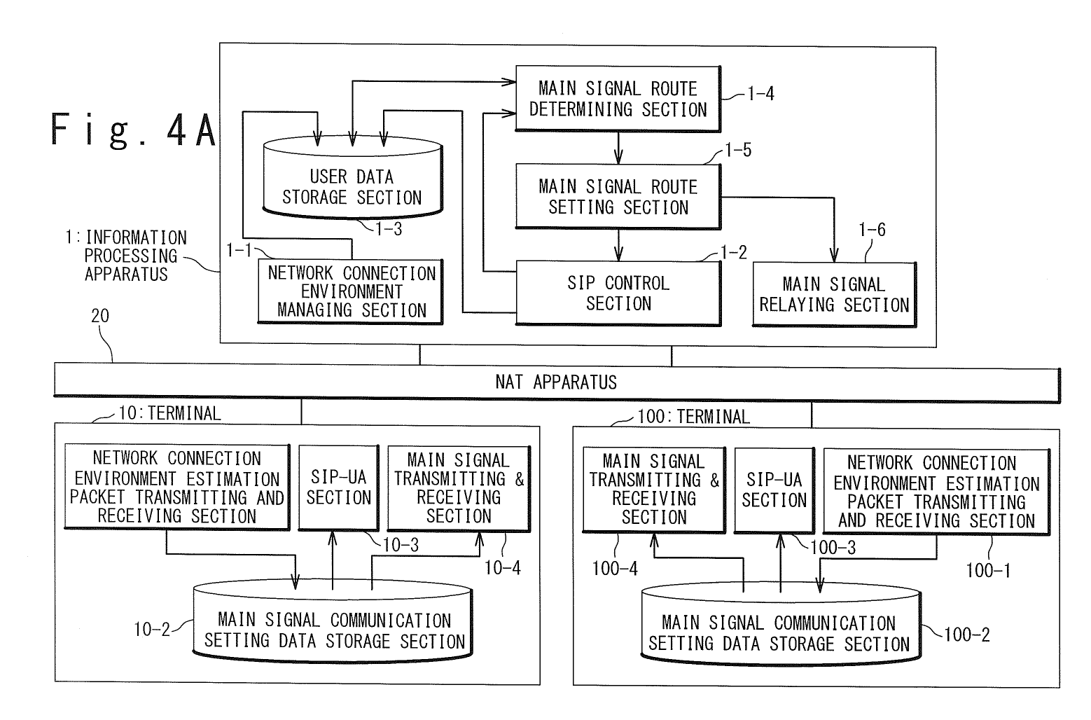

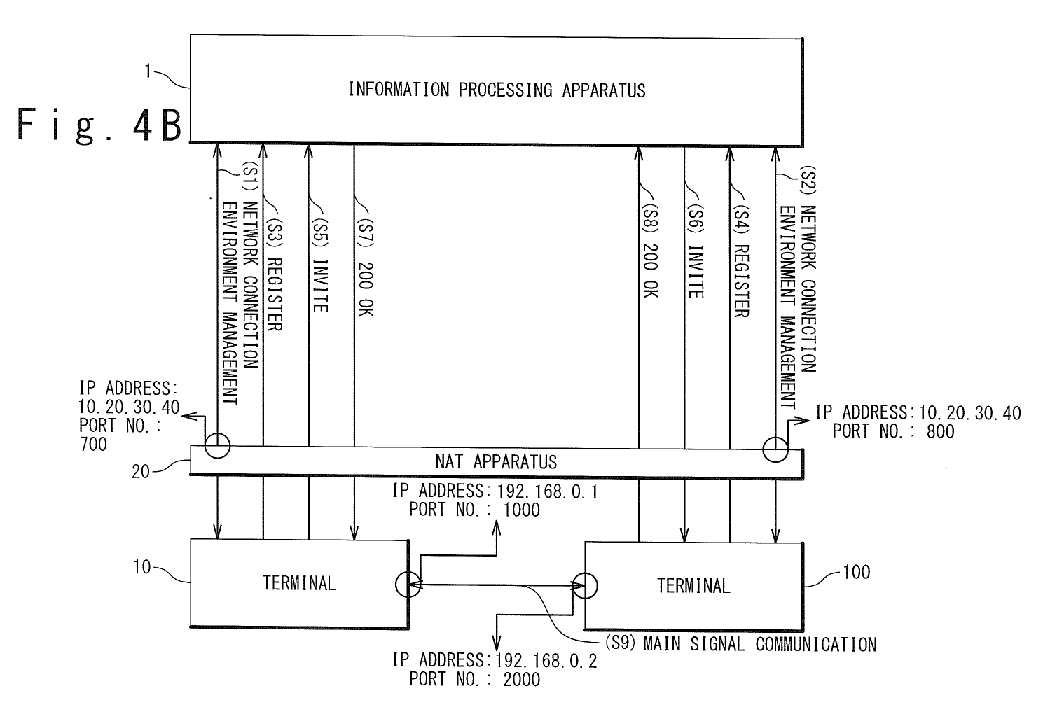

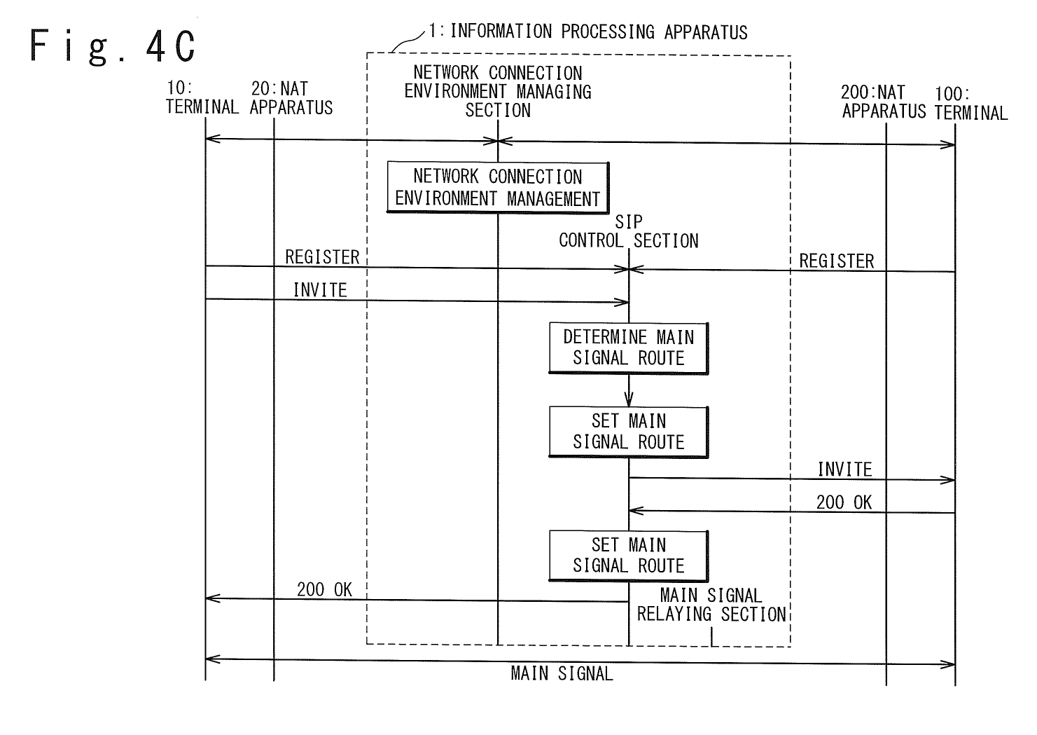

The operation of the system will be described with reference to FIGS. 4A, 4B, and 4C.

### <Operation of Network Connection Environment Management>

The recognition and acquisition of network connection environment have already been described in “(A) Case of no NAT apparatus” and ” (B) Case of a NAT apparatus on one side, accordingly the difference therebetween will be described here. The terminal 10 is a single NAT apparatus. In the operation of network connection environment management performed between the network connection environment estimation packet transmitting and receiving section 10-1 of the terminal 10 and the network connection environment managing section 1-1 of the information processing apparatus 1, when recognizing that the terminal 10 is under a Cone-type NAT apparatus or a Symmetric NAT apparatus, the network connection environment managing section 1-1 of the information processing apparatus 1 acquires a data indicating that the terminal 10 is under a Cone-type NAT apparatus or a Symmetric NAT apparatus, and the IP address of “10. 20. 30. 40” and the port number of “No. 700” mapped to the NAT apparatus 20 for the terminal 10 to communicate through the NAT apparatus 20. The obtained data is stored in the user data storage section 1-3. The network connection environment managing section 1-1 notifies the IP address of “10. 20. 30. 40” and the port number of “No. 700” mapped to the NAT apparatus 20 to the network connection environment estimation packet transmitting and receiving section 10-1 of the terminal 10. The network connection environment estimation packet transmitting and receiving section 10-1 of the terminal 10 stores the notified IP address and port number in the main signal communication setting data storage section 10-2. In the terminal 100 as well, the network connection environment managing section 1-1 acquires a data indicating that the terminal 100 is under a Cone-type NAT apparatus or a Symmetric NAT apparatus, and the IP address of “10. 20. 30. 40” and the port number of “No. 800” mapped to the NAT apparatus 200 for the terminal 100 to perform communication through the NAT apparatus 200. The obtained data is stored in the user data storage section 1-3. The network connection environment managing section 1-1 notifies the IP address of “10. 20. 30. 40” and the port number of “No. 800” mapped to the NAT apparatus 200 to the network connection environment estimation packet transmitting and receiving section 100-1 of the terminal 100. The network connection environment estimation packet transmitting and receiving section 100-1 of the terminal 100 stores the notified IP address and port number in the main signal communication setting data storage section 100-2.

### <Operation of SIP REGISTER>

The SIP REGISTER operation is the same as one when the network connection environment is “(A) The case of no NAT apparatus”, and will not be described here. In the above description, the operation of network connection environment management is performed first followed by the SIP REGISTER operation. However, this order may be reversed.

<SIP Sequence (from INVITE to 200 OK)>

Exchange of SIP messages will be described in which the communication is started from the terminal 10. The SIP-UA section 10-3 of the terminal 10 transmits an INVITE message destined to the terminal 100, to the information processing apparatus 1. The IP address of “10. 20. 30. 40” and the port number of “No. 700” have been written in a main signal communication setting section of the message. The SIP control section 1-2 of the information processing apparatus 1 receives the INVITE message destined to the terminal 100, and then notifies a data indicating that communication will be performed between the terminals 10 and 100 to the main signal route determining section 1-4, to determine a route of the main signal communication. The main signal route determining section 1-4 then inquires network connection environment data of the terminals 10 and 100 to the user data storage section 1-3 to obtain it, and determines the route from the network connection environment data of the terminals 10 and 100. It is judged that the main signal communication between the terminals 10 and 100 can directly be performed without traversing the NAT apparatus 20 from judgment that the terminals 10 and 100 have the same IP address (the IP address of “10. 20. 30. 40”) obtained at the time of the network connection environment management, and the data concerning the judgment is notified to the main signal route setting section 1-5. The communication route is shown in FIG. 4B. The main signal route setting section 1-5 refers to a main signal standby IP address and a port number in the INVITE message transmitted from the terminal 10, to confirm that the IP address and the port number are set to “10. 20. 30. 40” and “No. 700”, respectively, and rewrites the IP address and the port number to “192. 168. 0. 1” and “No. 1000”, respectively, to perform direct communication between the terminals 10 and 100 without traversing the NAT apparatus 20. The main signal route setting section 1-5 also notifies a data indicating that a main signal is not relayed, to the main signal relaying section 1-6. After that, the SIP control section 1-2 transmits the rewritten INVITE message to the terminal 100. When receiving the INVITE message, the terminal 100 transmits a reply (200 OK) message, to the SIP control section 1-2 of the information processing apparatus 1. The IP address of “10. 20. 30. 40” and the port number of “No. 800” are written in a main signal communication setting section of the message. The SIP control section 1-2, which has received the reply (200 OK) message from the terminal 100, notifies the main signal route determining section 1-4 of the reception. The route determined when the INVITE message has transmitted from the terminal 10, is notified to the main signal route setting section 1-5. The main signal route setting section 1-5 refers to a main signal standby IP address and a port number to confirm that the IP address and the port number are set to “10. 20. 30. 40” and “No. 800”, respectively, and rewrites the IP address and the port number to “192. 168. 0. 2” and “No. 2000”, respectively, to perform direct communication between the terminals 10 and 100 without traversing the NAT apparatus 20. After that, the SIP control section 1-2 transmits the rewritten reply (200 OK) message to the terminal 100. The procedure before the start of the main signal communication is completed here.

### <Main Signal Communication>

The terminal 10 performs the main signal communication by setting the standby IP address of “192. 168. 0. 1” and the port number of “No. 1000” for the main signal communication, and the IP address of “192. 168. 0. 2” and the port number of “No. 1000” written in the reply (200 OK) message from the terminal 100 received from the SIP control section 1-2 of the information processing apparatus 1 as the destination IP address and the port number for the main signal communication. The terminal 100 performs the main signal communication by setting the standby IP address of “192. 168. 0. 2” and the port number of “No. 2000” for the main signal communication, and the IP address of “192. 168. 0. 1” and the port number of “No. 1000” for the main signal communication written in the INVITE message from the terminal 10 received from the SIP control section 1-2 of the information processing apparatus 1 as the destination IP address and the port number for the main signal communication.

Although the SIP (Session Initiation Protocol) operation is described in the exemplary embodiments, the SIP is not the only method when other methods to control a session of the main signal communication are available.

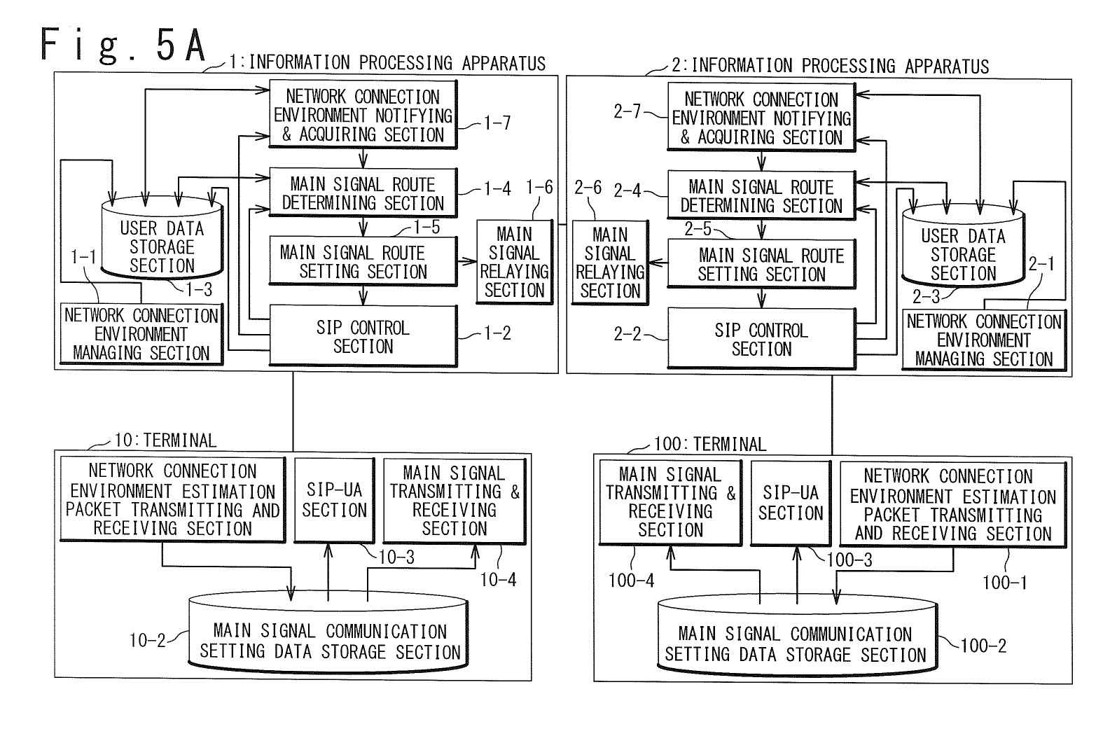

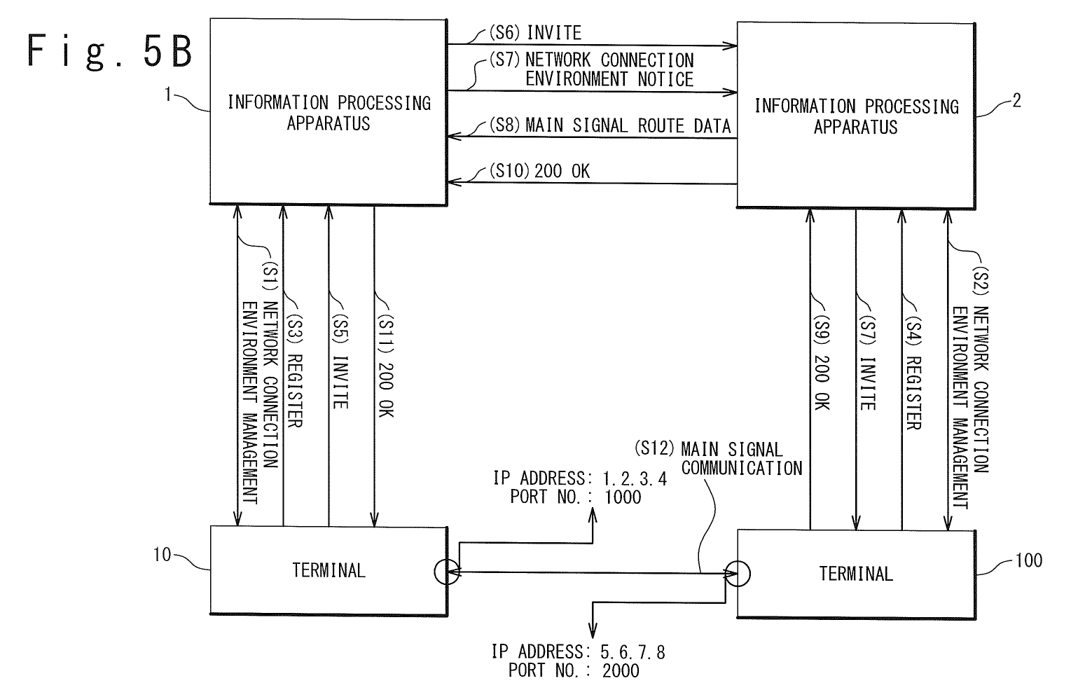

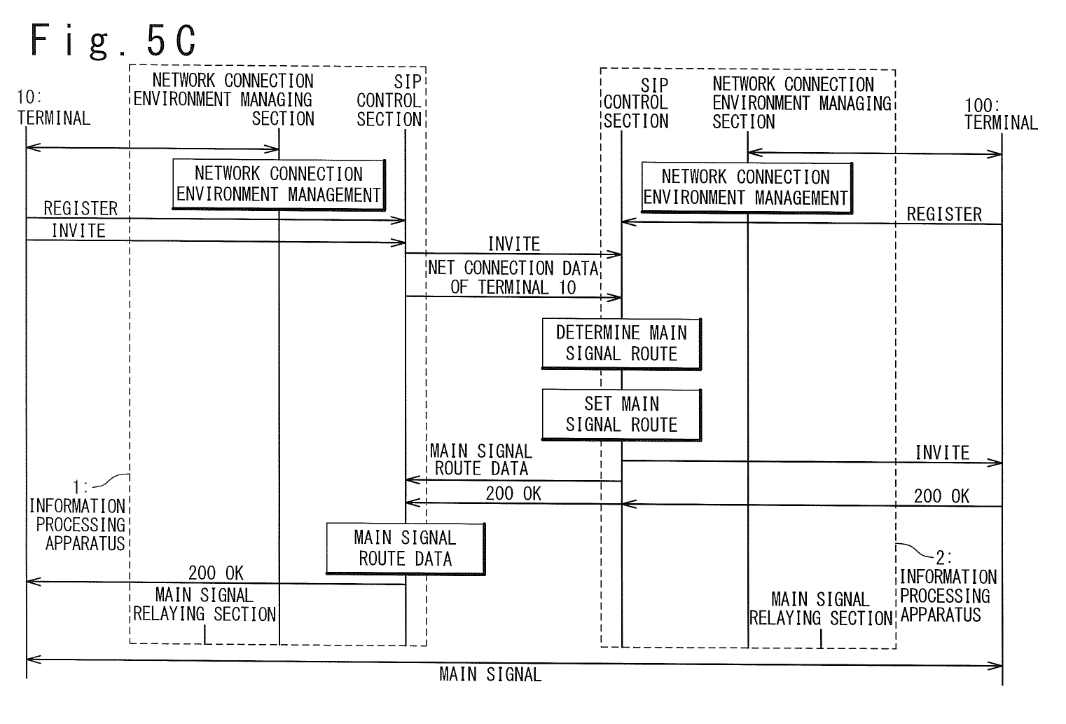

Next, the second exemplary embodiment of the present invention will be described with reference to the attached drawings. As shown in FIG. 5A, a plurality of information processing apparatuses are used in the exemplary embodiment. Here, an information processing system of the present invention has information processing apparatuses 1 and 2 and terminals 10 and 100. The information processing apparatuses 1 and 2 are configured in the same way. The terminals 10 and 100 are configured in the same way, having the same configuration as the terminal 10 described in the first exemplary embodiment.

The information processing apparatus 1 partly has the same configuration as the information processing apparatus 1 described in the first exemplary embodiment, and accordingly, the difference therebetween will be described here. The information processing apparatus 1 has a network connection environment notifying and acquiring section 1-7, which performs notification and acquisition of network connection environment data of a terminal to the information processing apparatus, in addition to the configuration of the information processing apparatus 1 of the first exemplary embodiment. In other words, the information processing apparatus 1 of the exemplary embodiment has a network connection environment managing section 1-1, an SIP control section 1-2, a user data storage section 1-3, a main signal route determining section 1-4, a main signal route setting section 1-5, a main signal relaying section 1-6, and the network connection environment notifying and acquiring section 1-7. Similarly, the information processing apparatus 2 has a network connection environment managing section 2-1, an SIP controlling section 2-2, a user data storage section 2-3, a main signal route determining section 2-4, a main signal route setting section 2-5, a main signal relaying section 2-6, and a network connection environment notifying and acquiring section 2-7.

The operation when the terminals 10 and 100 perform the main signal communication will be described in accordance with the respective network connection environment data of the terminals. The operation is partly the same as the operation in the first exemplary embodiment, and accordingly the difference therebetween will be described here.

The terminal 10 performs the recognition and acquisition of network connection environment and SIP REGISTER for the information processing apparatus 1 while the terminal 100 performs the network connection environment recognition and SIP REGISTER for the information processing apparatus 2. Communication will be started from the terminal 10, as in the case of the first exemplary embodiment. The difference from the first exemplary embodiment is the operation after the information processing apparatus 1 receives an INVITE message from the terminal 10.

When receiving an INVITE message destined to the terminal 100, the information processing apparatus 1 notifies the network connection environment notifying and obtaining section 1-7 of data that communication will be performed between the terminals 10 and 100. The network connection environment notifying and obtaining section 1-7 then obtains network connection environment data of the terminal 10 from the user data storage section which manages user data of the terminal 100, the network on 1-3 and notifies the information processing apparatus 2, connection environment data of the terminal 10.

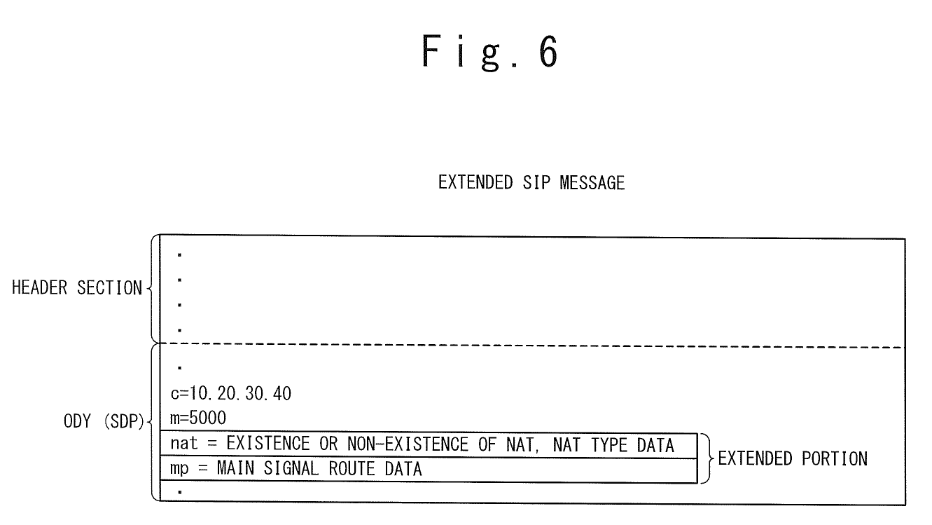

The SIP control section 1-2 of the information processing apparatus 1 also forwards an INVITE message to the SIP controlling section 2-2 of the information processing apparatus 2. It is described here, that the notification of the network connection environment data of the terminal 10 to the information processing apparatus 2 should be made by a message, separated from the transmission of the INVITE message. However, the data may be written in the INVITE message. An SIP message format in that case is shown in FIG. 6.

An example of an extended SIP message format will be described with reference to FIG. 6. The extended SIP message includes a header section and a body (SDP). The body (SDP) includes an IP address, a port number, and an extended part. The extended part includes “presence of a NAT apparatus”, “NAT apparatus-type data”, and “main signal route data”. The “presence of a NAT apparatus” is data concerning whether a NAT apparatus is present between an information processing apparatus and a terminal. The “NAT apparatus-type data” is a data concerning, when a NAT apparatus is present, whether the NAT apparatus is a Cone-type NAT apparatus or a Symmetric NAT apparatus. The “main signal route data” is a data concerning a route determined in accordance with network connection environment data.

After the information processing apparatus 2 receives the network connection environment data of the terminal 10 and the INVITE message from the information processing apparatus 1, the main signal route determining section 2-4 acquires the network connection environment data of the terminal 100 from the user data storage section 2-3 and determines a route. The main signal route determining section 2-4 notifies the determined route to the main signal route setting section 2-5 and the main signal route setting section 1-5 of the information processing apparatus 1. The main signal route setting section 2-5 performs or does not perform rewrite of a main signal standby IP address and a port number in accordance with the determined main signal communication route.

After that, the SIP controlling section 2-2 of the information processing apparatus 2 forwards the INVITE message to the terminal 100. When receiving the INVITE message, the SIP-UA section 100-3 of the terminal 100 transmits a reply (200 OK) message to the information processing apparatus 2. When receiving the reply (200 OK) message, the SIP controlling section 2-2 of the information processing apparatus 2 to forward the reply (200 OK) message to the SIP control section 1-2 of the information processing apparatus 1. Although the description has been given that the notification of main signal route data to the information processing apparatus 1 should be transmitted through a unique message after a route is determined, the main signal route data may be written in the reply (200 OK) message as shown in FIG. 6.

When receiving the reply message from the terminal 100, the SIP control section 1-2 of the information processing apparatus 1 notifies the reception of the reply (200 OK) message from the terminal 100 to the main signal route determining section 1-4. The main signal route determining section 1-4 receives the notification, and then notifies the route data determined by the main signal route determining section 2-4 of the information processing apparatus 2 to the main signal route setting section 1-5. The main signal route setting section 1-5 confirms the main signal standby IP address and the port number in the reply (200 OK) message and performs or does not perform rewrite in accordance with the determined main signal communication route.

After that, the SIP control section 1-2 of the data professing apparatus 1 forwards the reply (200 OK) message to the terminal 10.

A network configuration, communication between a terminal and an information processing apparatus, determination of a main signal route, and a route setting method will be described in accordance with network connection environment data.

### (D) Case of no NAT Apparatus

The operation of the system will be described with reference to FIGS. 5A, 5B, and 5C.

Comparing the configuration of FIG. 1A (“(A) Case of no NAT apparatus” in the first exemplary embodiment of the present invention) and the configuration of FIG. 5A, only a single information processing apparatus is added to the exemplary embodiment in addition to the configuration of the first exemplary embodiment.

Comparing FIG. 1B and FIG. 5B on communication between a terminal and an information processing apparatus, only (S6) INVITE message, (S7) network connection environment notification, (S8) main signal route data, and (S10) 200 OK message in FIG. 5B are added to “(A) The case of no NAT apparatus” in the first exemplary embodiment.

When FIG. 1B and FIG. 5B are compared on the main signal route determination and the route setting, the same applies as ” (A) Case of no NAT apparatus” in the first exemplary embodiment.

### (E) Case of a NAT Apparatus on One Side

### 1. Case of a Cone-type NAT Apparatus

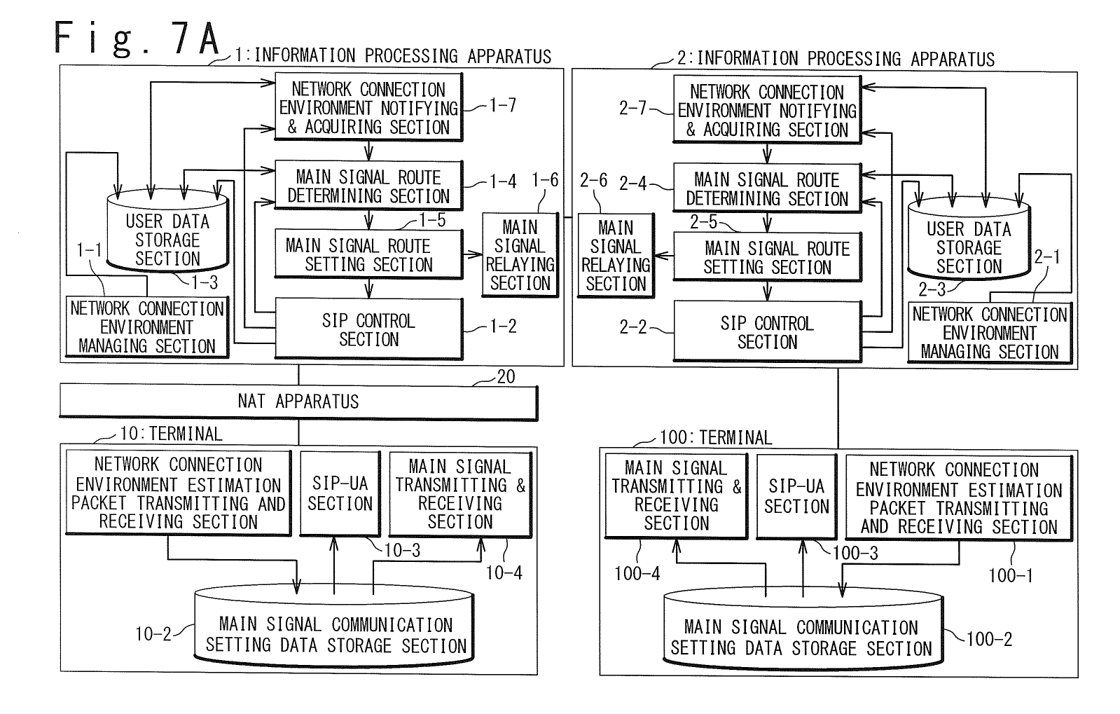

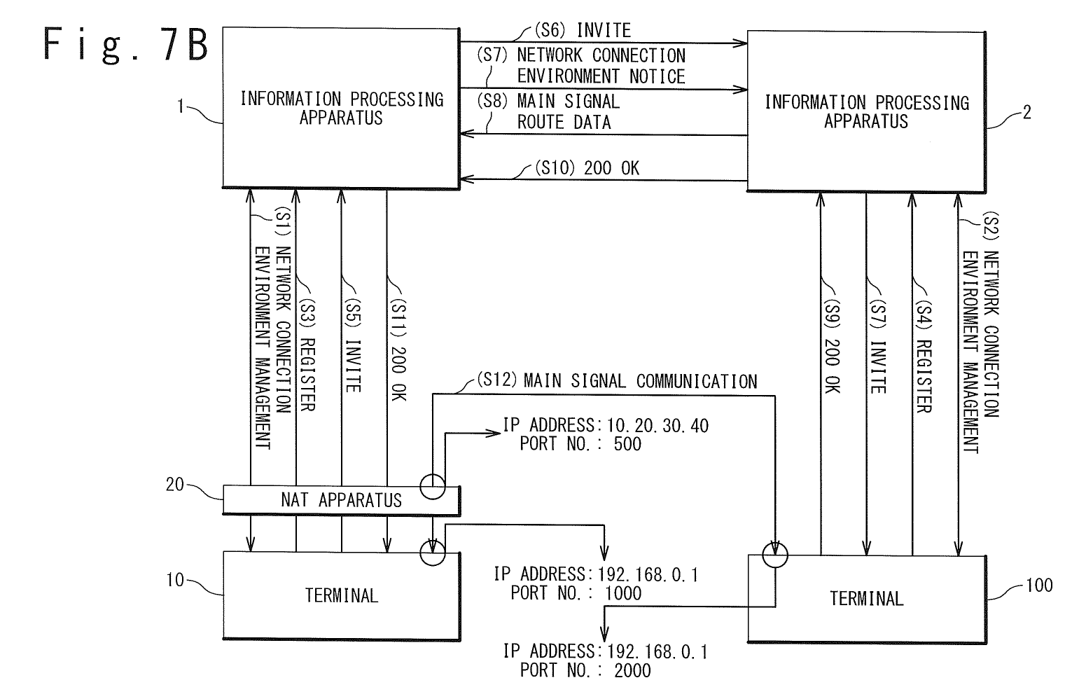

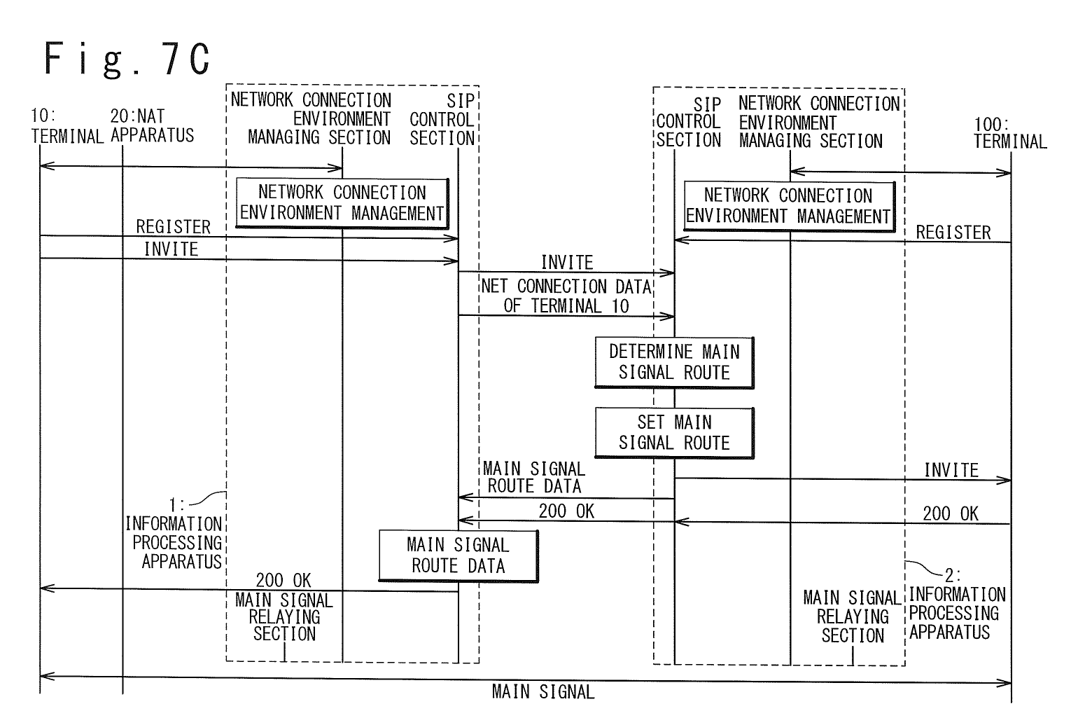

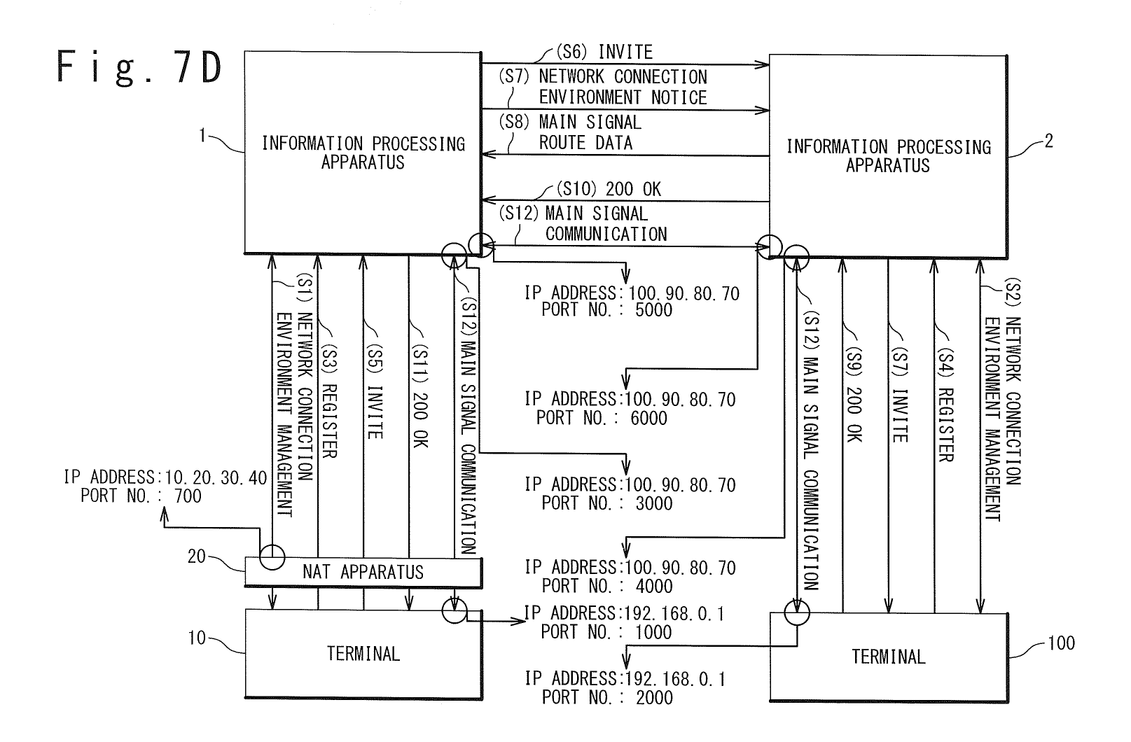

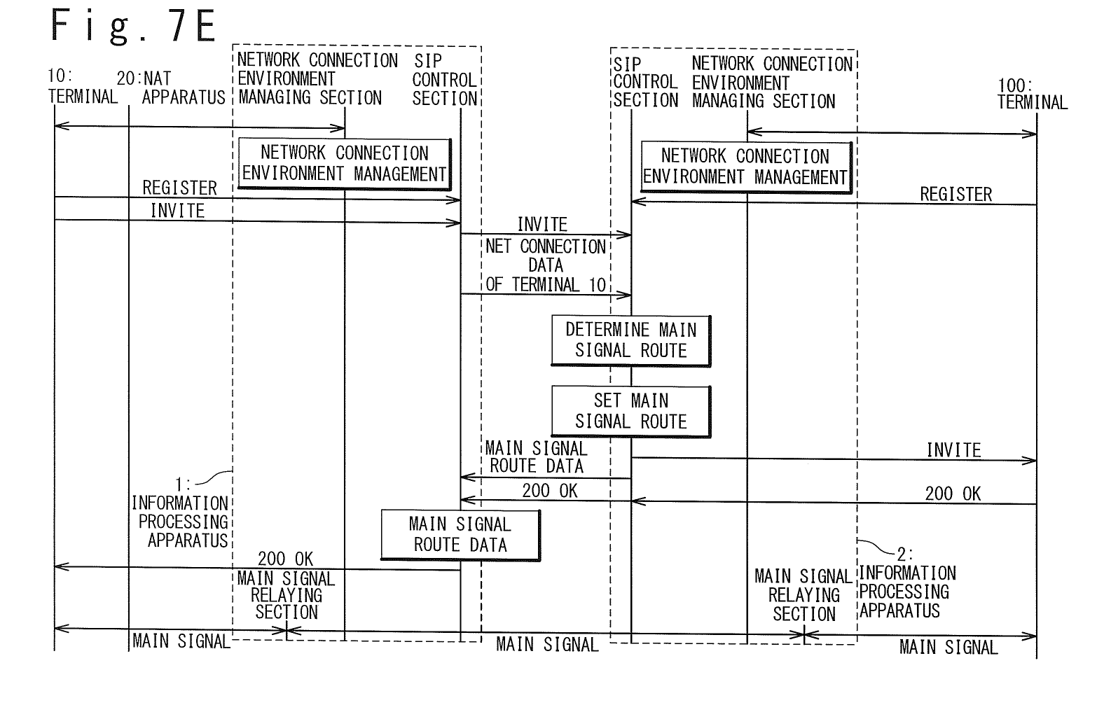

The operation of the system will be described with reference to FIGS. 7A, 7B, and 7C.

Comparing FIG. 2A (“(B) The case of a NAT apparatus on one side” in the first exemplary embodiment of the present invention as well as the case that the NAT apparatus is a Cone-type NAT apparatus (“1. Case of a Cone-type NAT apparatus”)) and FIG. 7A about a network configuration, only a single information processing apparatus is added to the configuration of the first exemplary embodiment.

Comparing FIG. 2B (“(B) Case of a NAT apparatus on one side” in the first exemplary embodiment of the present invention as well as the case that the NAT apparatus is a Cone-type NAT apparatus (“1. Case of a Cone-type NAT apparatus”)) and FIG. 7B about communication between a terminal and an information processing apparatus, only (S6) INVITE message, (S7) network connection environment notification, (S8) main signal route data, and (S10) 200 OK message of FIG. 7B are added to ” (B) Case of a NAT apparatus on one side” in the first exemplary embodiment of the present invention as well as the case where the NAT apparatus is a Cone-type NAT apparatus (“1. Case of a Cone-type NAT apparatus”).

Comparing FIG. 2B (“(B) The case of a NAT apparatus on one side” in the first exemplary embodiment of the present invention as well as the case where the NAT apparatus is a Cone-type NAT apparatus (“1. The case of a Cone-type NAT apparatus”)) and FIG. 7B concerning determination of a main signal route and a route setting method, the same applies as ” (B) The case of a NAT apparatus on one side” in the first exemplary embodiment of the present invention as well as the case where the NAT apparatus is a Cone-type NAT apparatus (“1. Case of a Cone-type NAT apparatus”).

### 2. Case of a Symmetric NAT Apparatus

The operation of the system will be described with reference to FIGS. 7A, 7D, and 7E.

Comparing FIG. 2A (“(B) The case of a NAT apparatus on one side” in the first exemplary embodiment of the present invention as well as the case that the NAT apparatus is a Symmetric NAT apparatus (“2. Case of a Symmetric NAT apparatus”)) and FIG. 7A about a network configuration, only a single information processing apparatus is added to the configuration of the first exemplary embodiment.

Comparing FIG. 2D ((“(B) Case of a NAT apparatus on one side” in the first exemplary embodiment of the present invention as well as the case that the NAT apparatus is a Symmetric NAT apparatus (“2. Case of a Symmetric NAT apparatus”)) and FIG. 7D about communication between a terminal and an information processing apparatus, only (S6) INVITE message, (S7) network connection environment notification, (S8) main signal route data, and (S10) 200 OK message of FIG. 7D are added to “(B) Case of a NAT apparatus on one side” in the first exemplary embodiment of the present invention as well as the case that the NAT apparatus is a Symmetric NAT apparatus (“2. Case of a Symmetric NAT apparatus”).

Comparing FIG. 2D (“(B) The case of a NAT apparatus on one side” in the first exemplary embodiment of the present invention as well as the case that the NAT apparatus is a Symmetric NAT apparatus (“2. Case of a Symmetric NAT apparatus”)) and FIG. 7D about determination of a main signal route and setting of a route, a route through which a main signal is relayed between the information processing apparatuses 1 and 2 is added and just the route is set, in addition to “(B) Case of a NAT apparatus on one side” in the first exemplary embodiment of the present invention as well as the case where the NAT apparatus is a Symmetric NAT apparatus (“2. Case of a Symmetric NAT apparatus”). (F) Case of NAT apparatus on both sides

### 1. The Case of a Cone-type NAT Apparatus and a Cone-Type NAT Apparatus

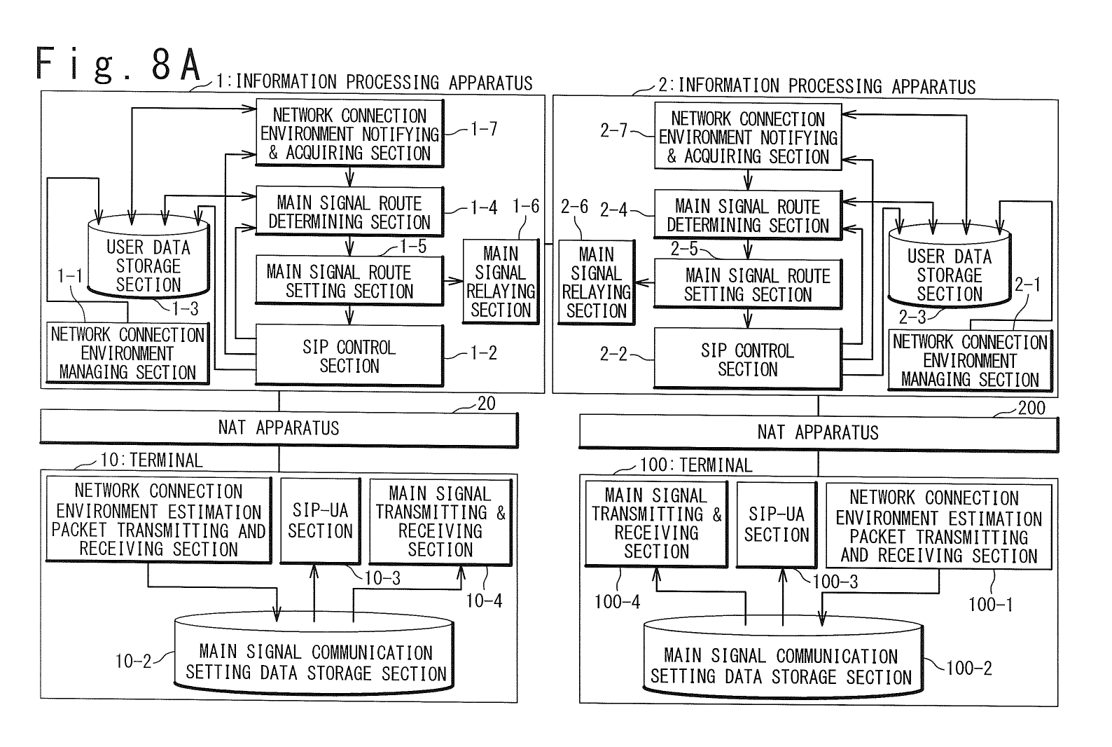

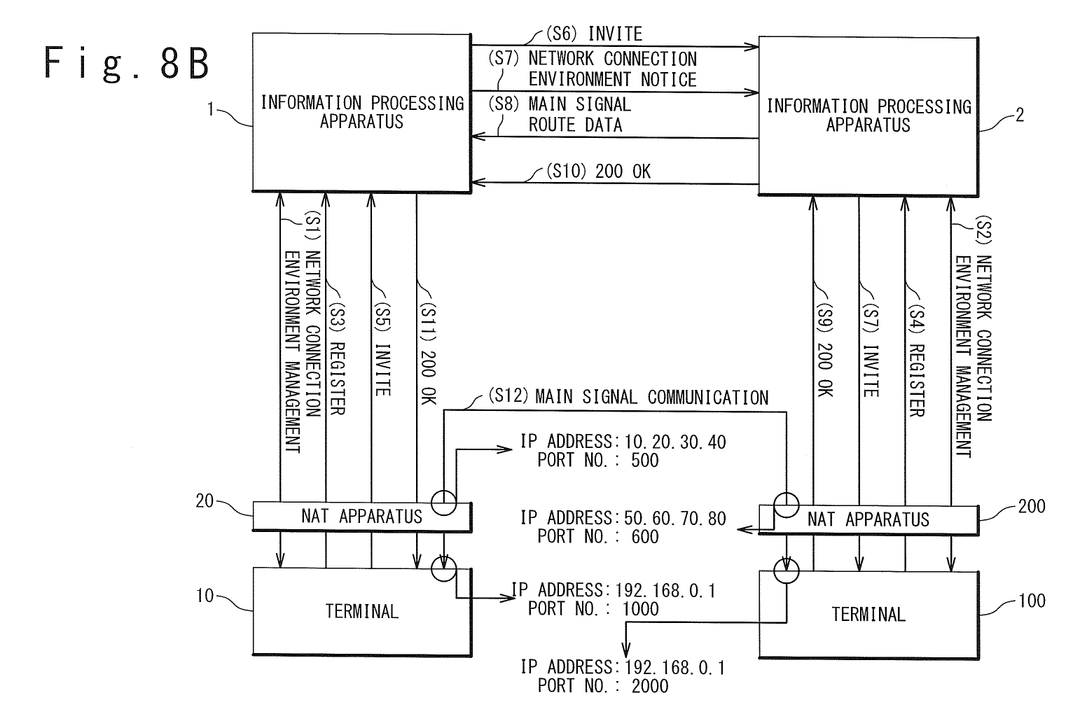

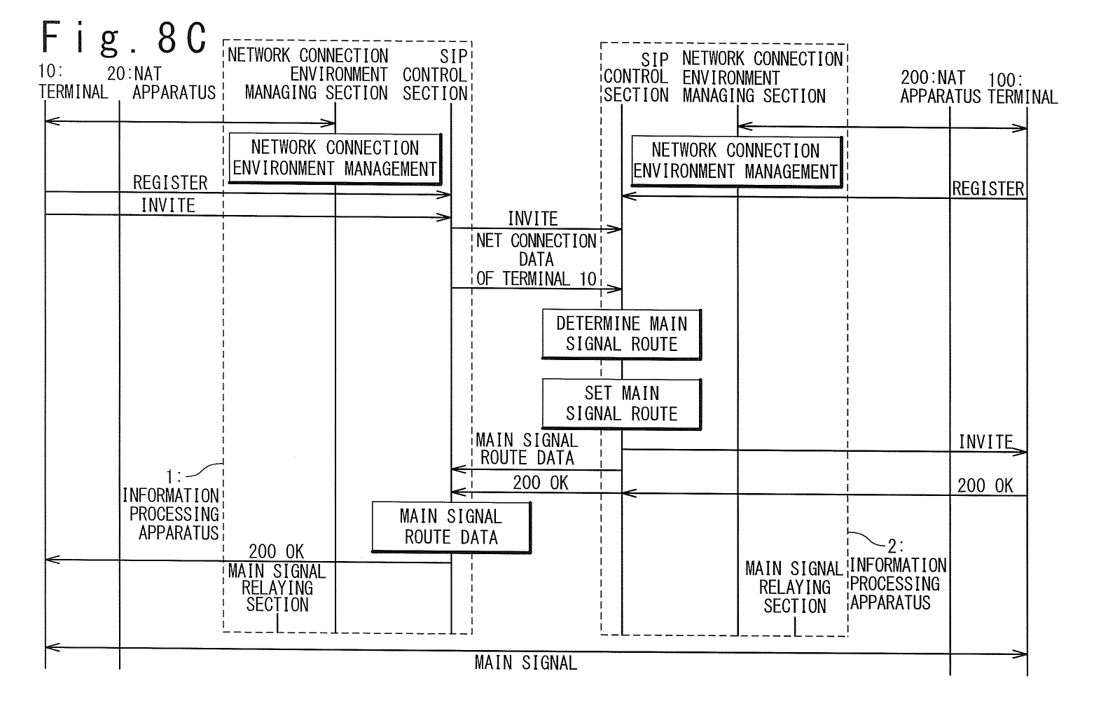

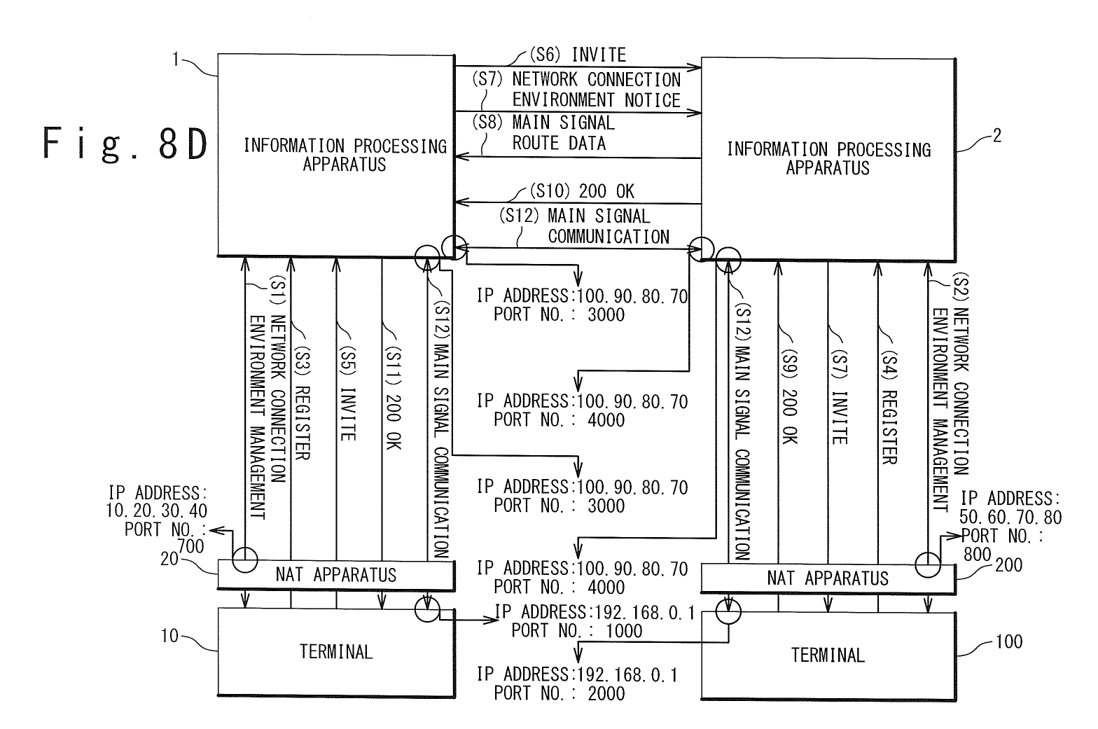

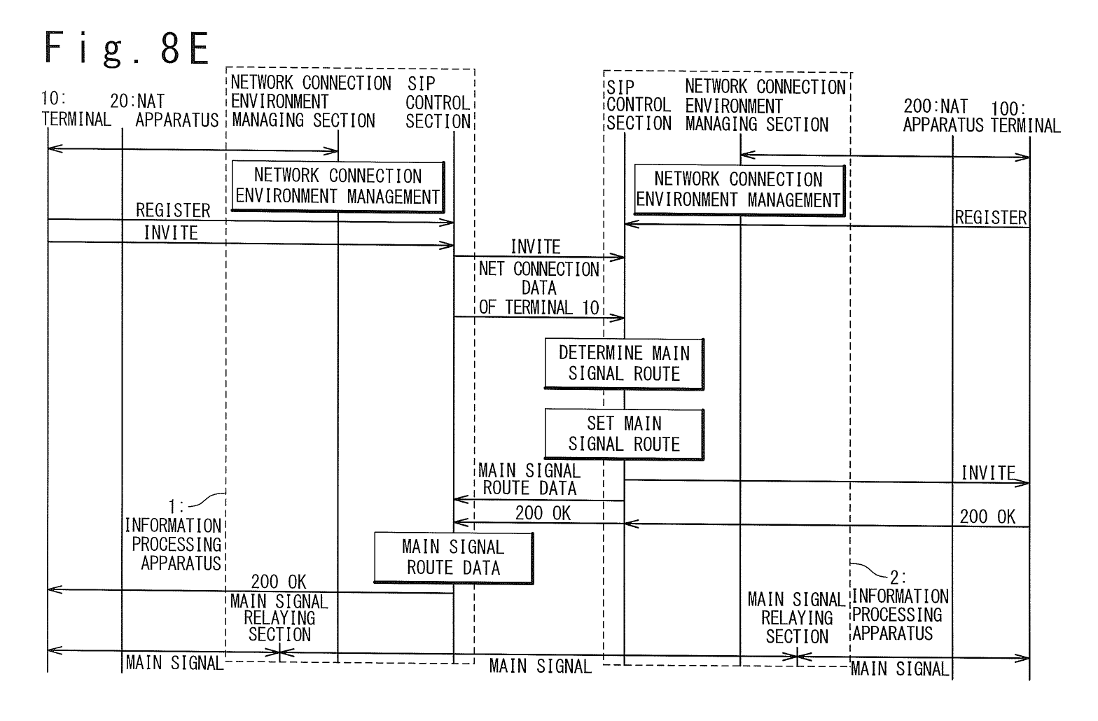

The operation of the system will be described with reference to FIGS. 8A, 8B, and 8C.

Comparing FIG. 3A (“(C) Case of NAT apparatus on both sides” in the first exemplary embodiment of the present invention as well as the case that Cone-type NAT apparatuses are present on both sides (“1. Case of a Cone-type NAT apparatus and a Cone-type NAT apparatus”)) and FIG. 8A about a network configuration, only a single information processing apparatus is added to the configuration of the first exemplary embodiment.

Comparing FIG. 3B (“(C) Case of NAT apparatus on both sides” in the first exemplary embodiment of the present invention as well as the case that Cone-type NAT apparatuses are present on both sides (“1. Case of a Cone-type NAT apparatus and a Cone-type NAT apparatus”)) and FIG. 8B about communication between a terminal and an information processing apparatus, only (S6) INVITE message, (S7) network connection environment notification, (S8) main signal route data, and (S10) 200 OK message of FIG. 7B are added to “(B) Case of a NAT apparatus on one side” in the first exemplary embodiment of the present invention as well as the case where the NAT apparatus is a Cone-type NAT apparatus (“1. Case of a Cone-type NAT apparatus”).

Comparing FIG. 3B (“(C) Case of NAT apparatus on both sides” in the first exemplary embodiment of the present invention as well as the case that Cone-type NAT apparatuses are present on both sides (“1. Case of a Cone-type NAT apparatus and a Cone-type NAT apparatus”)) and FIG. 8B about determination of a main signal route and setting of a route, the same applies as “(C) Case of NAT apparatus on both sides” in the first exemplary embodiment of the present invention as well as the case where Cone-type NAT apparatuses are present on both sides (“1. Case of a Cone-type NAT apparatus and a Cone-type NAT apparatus”).

### 2. Case of a Cone-type NAT Apparatus and a Symmetric NAT Apparatus

The operation of the system will be described with reference to FIGS. 8A, 8D, and 8E.

Comparing FIG. 3A (“(C) Case of NAT apparatus on both sides” in the first exemplary embodiment of the present invention as well as the case where a Cone-type NAT apparatus is present on one side and a Symmetric NAT apparatus is present on the other side (“2. Cone-type NAT apparatus and Symmetric NAT apparatus”)) and FIG. 8A concerning a network configuration, only a single information processing apparatus is added in addition to the configuration of the first exemplary embodiment.

Comparing FIG. 3D (“(C) The case of NAT apparatus on both sides” in the first exemplary embodiment of the present invention and the case where a Cone-type NAT apparatus is present on one side and a Symmetric NAT apparatus is present on the other side (“2. Case of a Cone-type NAT apparatus and a Symmetric NAT apparatus”)) and FIG. 8D about communication between a terminal and an information processing apparatus, only (S6) INVITE message, (S7) network connection environment notification, (S8) main signal route data, and (S10) 200 OK message of FIG. 7B are added to “(B) Case of a NAT apparatus on one side” in the first exemplary embodiment of the present invention as well as the case where the NAT apparatus is a Cone-type NAT apparatus (“1. Case of a Cone-type NAT apparatus”).

Comparing FIG. 3D (“(C) Case of NAT apparatus on both sides” in the first exemplary embodiment of the present invention as well as the case that a Cone-type NAT apparatus is present on one side and a Symmetric NAT apparatus is present on the other side (“2. Case of a Cone-type NAT apparatus and a Symmetric NAT apparatus”)) and FIG. 8B about determination of a main signal route and setting of a route, a route through which a main signal is relayed between the information processing apparatuses 1 and 2 is added and just the route is set in addition to “(C) Case of NAT apparatus on both sides” in the first exemplary embodiment of the present invention as well as the case where a Cone-type NAT apparatus is present on one side and a Symmetric NAT apparatus is present on the other side (“2. Case of a Cone-type NAT apparatus and a Symmetric NAT apparatus”).

### 3. The Case of a Symmetric NAT Apparatus and a Symmetric NAT Apparatus

The operation of the system will be described with reference to FIGS. 8A, 8D, and 8E.

As for a network configuration, communication between a terminal and an information processing apparatus, determination of a main signal route, and a route setting method, the same applies as “(C) Case of NAT apparatus on both sides” in the first exemplary embodiment of the present invention as well as the case where a Cone-type NAT apparatus is present on one side and a Symmetric NAT apparatus is present on the other side (“2. Case of a Cone-type NAT apparatus and a Symmetric NAT apparatus”).

### 4. Case of Connection to the Same NAT Apparatus

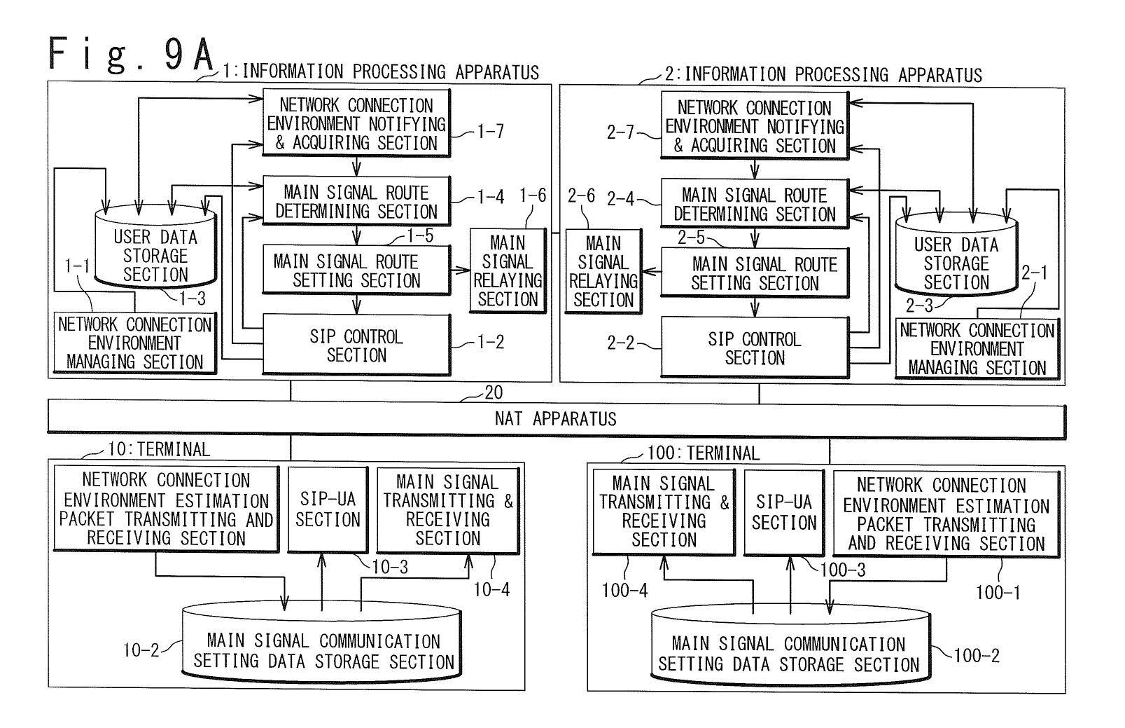

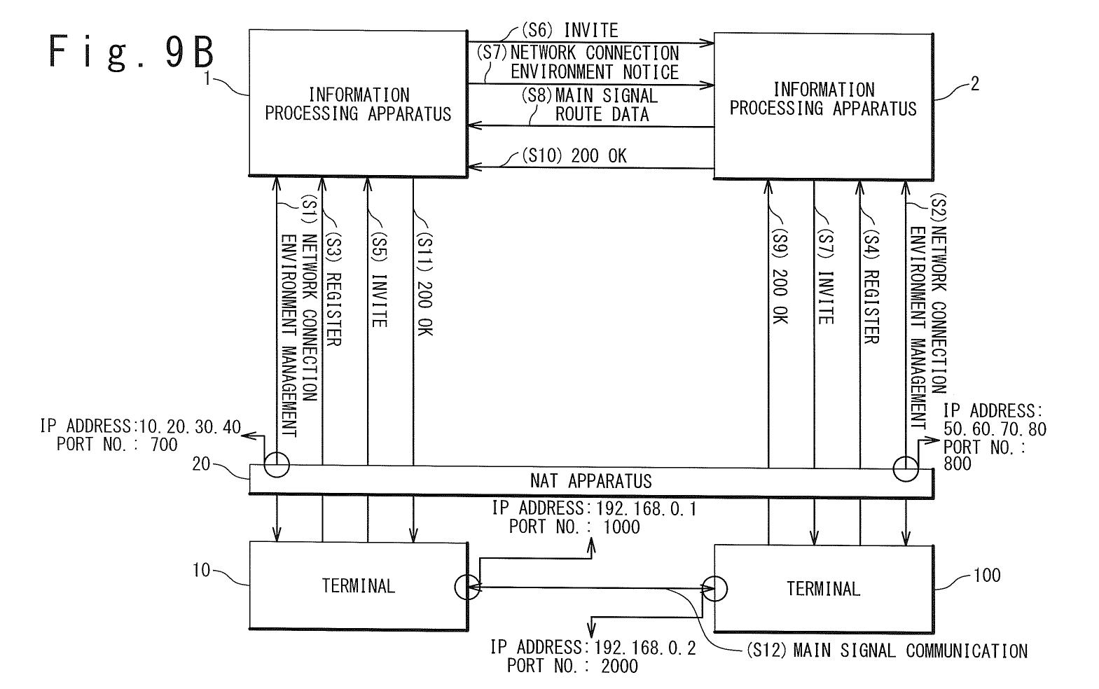

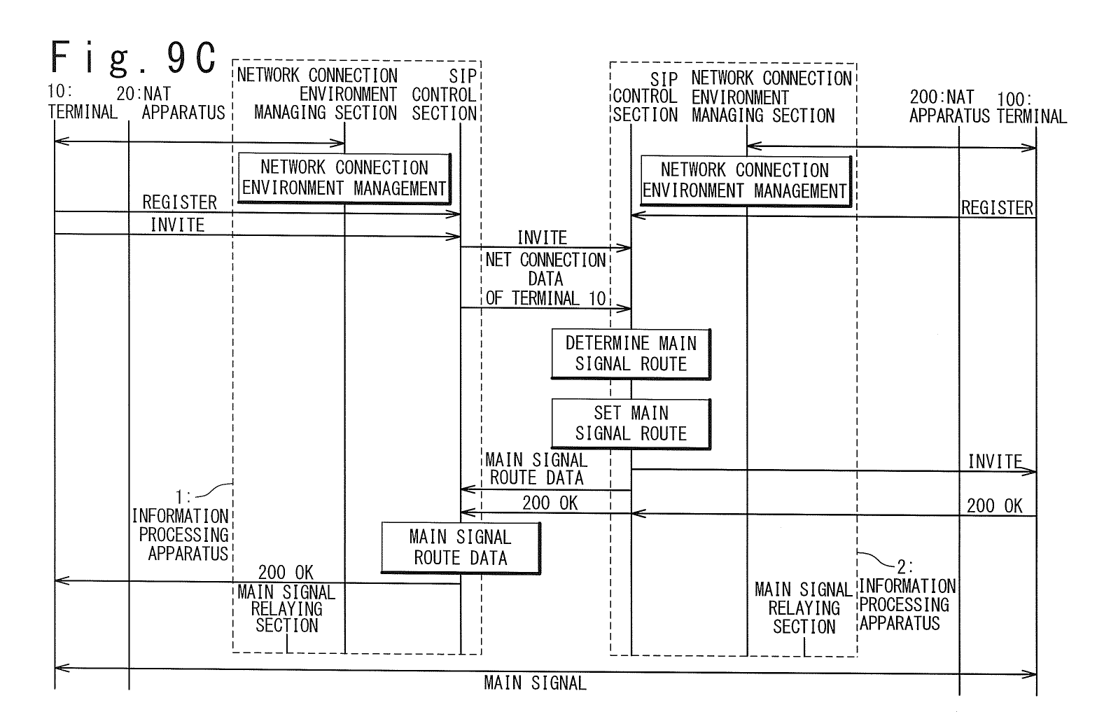

The operation of the system will be described with reference to FIGS. 9A, 9B, and 9C.

Comparing FIG. 4A (“(C) Case of NAT apparatus on both sides” in the first exemplary embodiment of the present invention as well as the case that both terminals are under the same NAT apparatus (“4. Case of connection to the same NAT apparatus”)) and FIG. 9A about a network configuration, only a single information processing apparatus is added to the configuration of the first exemplary embodiment.

Comparing FIG. 4B (“(C) Case of NAT apparatus on both sides” in the first exemplary embodiment of the present invention as well as the case that both terminals are under the same NAT apparatus (“4. Case of connection to the same NAT apparatus”)) and FIG. 9B about communication between a terminal and an information processing apparatus, only (S6) INVITE message, (S7) network connection environment notification, (S8) main signal route data, and (S10) 200 OK message of FIG. 5B are added to “(A) Case of no NAT apparatus” in the first exemplary embodiment.

Comparing FIG. 4B (“(C) Case of NAT apparatus on both sides” in the first exemplary embodiment of the present invention as well as the case that both terminals are under the same NAT apparatus (“4. Case of connection to the same NAT apparatus”)) and FIG. 5B about determination of a main signal route and a route setting method, the same applies as “(C) Case of NAT apparatus on both sides” in the first exemplary embodiment of the present invention as well as the case that both terminals are under the same NAT apparatus.

According to the present invention, an information processing system includes an information processing apparatus that performs call control and a terminal, and the information processing apparatus performs setting of an SDP in an SIP message in accordance with network connection environment data of the terminal.

When recognizing that at least one terminal among terminals performing communication is not under a Symmetric NAT apparatus but a Cone-type NAT apparatus, the information processing apparatus sets an SDP in an SIP message such that the terminal performs the main signal communication through the NAT apparatus through a route that the information processing apparatus does not perform relay.

The information processing apparatus sets an SDP in an SIP message such that the main signal communication is performed through relay at the information processing apparatus, when recognizing that at least one terminal among terminals performing communication is under a Symmetric NAT apparatus.

The information processing apparatus sets an SDP in an SIP message such that the main signal communication is directly performed without traversing the NAT apparatus, when recognizing that terminals performing communication are under the same NAT apparatus.

The information processing apparatus judges that terminals performing communication are under the same NAT apparatus from a global IP address assigned to the NAT apparatus.

Another information processing system of the present invention is a call control system that includes a plurality of information processing apparatuses for performing call control and terminals. The information processing system performs setting of an SDP in an SIP message in accordance with network connection environment data of their respective terminals.

The information processing apparatuses performs setting of an SDP in an SIP message by exchanging network connection environment data of their respective terminals and the main signal communication route data.

The information processing apparatuses uses a message created with a protocol different from an SIP, when exchanging network connection environment data of their respective terminals and the main signal communication route data determined by the information processing apparatuses.

When exchanging network connection environment data of their respective terminals and the main signal communication route data determined by the information processing apparatuses, the information processing apparatuses performs setting of an SDP in an SIP message by transmitting the SIP message after writing the data.

The information processing apparatuses writes network connection data of the terminals and the main signal communication route data in an SDP in an SIP message.

When at least one terminal among their respective terminals is not under a Symmetric NAT apparatus but a Cone-type NAT apparatus, the information processing apparatus sets an SDP in an SIP message such that the main signal communication is performed through the NAT apparatus.

The information processing apparatus is sets an SDP in an SIP message such that the main signal communication is performed through an information processing apparatus, when any of their respective terminals is under a Symmetric NAT apparatus.

The information processing apparatus sets an SDP in an SIP message such that the main signal communication is directly performed without traversing a NAT apparatus, when their respective terminals are under the same NAT apparatus.

The information processing apparatus judges that their respective terminals are under the same NAT apparatus from a global IP address assigned to the NAT apparatus.

In an information processing system of the present invention, an information processing apparatus sets an IP address and a port number for the main signal communication in an SIP message transmitted from a terminal in accordance with network connection environment data such that communication is possible between terminals. Also, in the information processing system of the present invention, an information processing apparatus relays a main signal when direct communication between terminals is not possible through a NAT apparatus.

Although the present invention has been described above in connection with several exemplary embodiments thereof, it will be appreciated by those skilled in the art that those exemplary embodiments are provided solely for illustrating the present invention, and should not be relied upon to construe the appended claims in a limiting sense.

Although the present invention has been described above in connection with several exemplary embodiments thereof, it will be appreciated by those skilled in the art that those exemplary embodiments are provided solely for illustrating the present invention, and should not be relied upon to construe the appended claims in a limiting sense.

What is claimed is:

1. An information processing system comprising: an information processing apparatus configured to perform a call control; and
terminals configured to communicate with said information processing apparatus,
wherein said information processing apparatus sets an SDP in an SIP message based on network connection environment data indicating existence or non-existence of a NAT (Network Address Translator) apparatus connected with each of said terminals and a type of said NAT apparatus.

2. The information processing system according to claim 1, wherein when confirming that at least one of said terminals is not a Symmetric NAT apparatus but a Cone system NAT apparatus, said information processing apparatus sets the SDP in the SIP message such that said terminals perform main signal communication through a route without relay by said information processing apparatus through said NAT apparatus.

3. The information processing system according to claim 1, wherein when confirming that at least one of said terminals is connected with the Symmetric NAT apparatus, said information processing apparatus sets the SDP in the SIP message such that main signal communication is performed by relaying by said information processing apparatus.

4. The information processing system according to claim 1, wherein when confirming that said terminals are under a single NAT apparatus, said information processing apparatus sets the SDP in the SIP message such that direct main signal communication is performed without passing through said information processing apparatus.

5. The information processing system according to claim 4, wherein said information processing apparatus determines whether said terminals are under the single NAT apparatus, based on a global IP address allocated for said NAT apparatus.

6. The information processing system according to claim 1, further comprising:
another information processing apparatus configured to exchange the network connection environment data and a main signal communication route data of each of said terminals managed by said another information processing apparatus with said information processing apparatus.

7. An information processing apparatus comprising:
a network connection environment managing section configured to acquire network connection environment data indicating existence or non-existence of a NAT (Network Address Translator) apparatus and a type of the NAT apparatus which is connected with a terminal and to notify a main signal communication setting data of said terminal;
a SIP control section configured to receive a SIP message transmitted from said terminal and to perform a control in response to a request from said terminal;
a user data storage section configured to store the network connection environment data and a registered user data from said terminal;
a main signal route determining section configured to determine a route of a main signal based on the network connection environment data stored in said user data storage section;
a main signal route setting section configured to rewrite the SIP message to perform communication on the route determined by said main signal route determining section; and
a main signal relaying section configured to relay the main signal based on data of said main signal route setting section.

8. The information processing apparatus according to claim 7, further comprising:
a network connection environment notifying and acquiring section configured to notify the network connection environment data of said terminal managed by said information processing apparatus to another information processing apparatus and to acquire network connection environment data of another terminal managed by said another information processing apparatus from said another information processing apparatus.

9. The information processing apparatus according to claim 7, wherein said terminal comprises:
a network connection environment estimation packet transmitting and receiving section configured to indicate the network connection environment data to said information processing apparatus;
a main signal communication setting data storage section configured to store a main signal communication setting data notified from said network connection environment estimation packet transmitting and receiving section;
a SIP-UA section configured to carry out transmission and reception of the SIP message; and
a main signal transmitting and receiving section configured to carry out transmission and reception of a main signal.

10. An information processing method comprising:
communicating between an information processing apparatus which performs a call control and a terminal; and
setting an SDP in a SIP message based on a network connection environment data indicating existence or non-existence of a NAT (Network Address Translator) apparatus which is connected with said terminal, and a type of the NAT apparatus in said information processing apparatus.

11. The information processing method according to claim 10, wherein said setting comprises:
setting the SDP in the SIP message such that said terminal performs a main signal communication on a route that is not relayed by said information processing apparatus while passing through said NAT apparatus when said information processing apparatus confirms that at least one of said terminal and a counter side terminal is under not a Symmetric NAT apparatus but a Cone NAT apparatus.

12. The information processing method according to claim 10, wherein said setting comprises:
setting the SDP in the SIP message such that the main signal communication is performed by relaying a main signal in said information processing apparatus, when said information processing apparatus confirms that at least one of said terminal and a counter side terminal is under a Symmetric NAT apparatus.

13. The information processing method according to claim 10, wherein said setting comprises:
setting the SDP in the SIP message such that a direct main signal communication is performed without passing through said NAT apparatus, when said information processing apparatus confirms that said terminal and a counter side terminal are under said NAT apparatus.

14. The information processing method according to claim 13, further comprising:
determining by said information processing apparatus that said terminal and said counter side terminal are under said NAT apparatus, based on a global IP address assigned to said NAT apparatus.

15. An information processing method comprising:
managing at least one terminal by each of information processing apparatuses which perform call control; and
setting an SDP in a SIP message based on a network connection environment data indicating existence or non-existence of a NAT (Network Address Translator) apparatus which is connected with said terminal, and a type of said NAT apparatus in each of said information processing apparatuses.

16. The information processing method according to claim 15, wherein said setting comprises:
setting the SDP in the SIP message by exchanging a main signal communication route data and the network connection environment data of said terminals managed by said information processing apparatuses between said information processing apparatuses.

17. The information processing method according to claim 16, wherein said setting comprises:
setting the SDP in the SIP message such that the main signal communication route data and the network connection environment data are exchanged, by using messages produced based on a protocol different from SIP.

18. The information processing method according to claim 16, wherein said setting comprises:
setting the SDP in the SIP message such that the main signal communication route data and the network connection environment data are exchanged, by transmitting a SIP message in which the main signal communication route data and the network connection environment data are written.

19. The information processing method according to claim 18, wherein said setting comprises:
writing the main signal communication route data and the network connection environment data in the SDP of the SIP message.

20. The information processing method according to claim 15, wherein said setting comprises:
setting the SDP in the SIP message such that the main signal communication is performed by passing through said NAT apparatus when said information processing apparatus confirms that said terminal is connected with not a Symmetric NAT apparatus but a Cone NAT apparatus.

21. The information processing method according to claim 15, wherein said setting comprises:
setting the SDP in the SIP message such that the main signal communication is performed through said information processing apparatuses when any one of said terminals managed by said information processing apparatuses is connected with a Symmetric NAT apparatus.

22. The information processing method according to claim 15, wherein said setting comprises:
setting the SDP in the SIP message such that direct signal communication is performed without passing through said NAT apparatus when said terminals managed by said information processing apparatuses are connected with said NAT apparatus.

23. The information processing method according to claim 22, wherein said setting comprises:
determining that said terminals managed by said information processing apparatuses are connected with said NAT apparatus, based on a global IP address assigned to said NAT apparatus.

24. A computer-readable software medium in which a program code is written to realize an information processing method, which comprises:
managing at least one terminal by each of information processing apparatuses which perform call control; and
setting an SDP in a SIP message based on a network connection environment data indicating existence or non-existence of a NAT (Network Address Translator) apparatus which is connected with said terminal, and a type of said NAT apparatus in each of said information processing apparatuses.
